(19) United States
(12) Patent Application Publication
(10) Pub. No.: US 2026/0265958 A1
(43) Pub. Date: Sep. 10, 2026

(54) FIBER AND FILAMENT FOR THREE-DIMENSIONAL PRINTING

(71) Applicant: OceanSafe AG, Bern (CH)

(72) Inventor: Manuel SCHWEIZER, Ittigen (CH)

(21) Appl. No.: 19/165,300

(22) PCT Filed: Mar. 15, 2024
(86) PCT No.: PCT/EP2024/056908

§ 371 Date: Sep. 15, 2025

(30) Foreign Application Priority Data
Mar. 15, 2023 (EP) 23162116.0

(51) Int. Cl. D01F 6/92; B29C 64/118; B33Y 70/00

(52) U.S. Cl. CPC D01F 6/92; B29C 64/118; B33Y 70/00; D10B 2331/04

(57) ABSTRACT

The present invention relates to a fiber being made from a mixture comprising an aliphatic polyester, an aliphatic-aromatic polyester, and a polyhydroxyalkanoate, and methods of preparing such fiber. The present invention also relates to a filament suitable for three-dimensional printing being made from a mixture comprising an aliphatic polyester, an aliphatic-aromatic polyester, and a polyhydroxyalkanoate, and methods of preparing such filament.

### CROSS-REFERENCE TO RELATED APPLICATION

The present application claims the benefit of priority of EP Patent Application No. 23162116.0 filed 15 Mar. 2023, the content of which is hereby incorporated by reference in its entirety for all purposes.

### TECHNICAL FIELD

The present invention relates to a fiber comprising an aliphatic polyester, an aliphatic-aromatic polyester and a polyhydroxyalkanoate, methods for preparing such fiber, and uses of such fiber in a yarn or a textile. The present invention also relates to a filament suitable for three-dimensional printing comprising an aliphatic polyester, an aliphatic-aromatic polyester and polyhydroxyalkanoate, methods for preparing such filament, and uses of such filament for three-dimensional printing.

### BACKGROUND

Sustainable textiles should be based on ecological, economic and social sustainability. A sustainable product should take these factors into account from raw material to processing, finishing, sales and recycling.

Fibers used in sustainable textiles today include, e.g., natural fibers such as cotton, wool, linen, SeaCeII™ (a cellulose fiber obtained from algae, which is produced from Smartfiber AG), recycled fibers such as recycled polyester (e.g. from polyethylene terephthalate (PET) bottles), Econyl® (a recycled nylon fiber), or regenerated fibers (regenerated fibers is a designation for fibers which are prepared from a natural material, such as wood, by a chemical process) such as Lyocell (e.g., known under the tradename Tencel™ from Lenzing) or Modal.

However, although these fibers are used in sustainable textiles, there are still various drawbacks. For example, cotton and wool production requires high water consumption and is associated with high land consumption. Obtaining recycled fibers, such as e.g. recycled PET, usually requires high amounts of energy, water and chemicals.

It is further desirable that sustainable textiles and fibers are suitable for being used under the concept of a circular economy. In particular, it is desirable that textiles and fibers can be used in the biological cycle, e.g. under the cradle-to-cradle design, by exhibiting suitable biodegradability and thus avoiding non-degradable waste. A beneficial guidance of a fiber or textile into the biological cycle is achieved when the textile product is returned after expiry of its life cycle and fed to industrial composting. This produces biomass and biogas (CH₄, CO₂, water), which can be fed directly into the biological cycle.

Thus, there is an ongoing need for fibers which, in particular, address ecological requirements. It is thus an object of the invention to provide such a fiber.

Similar considerations also apply for filaments which can be used for three-dimensional printing, and three-dimensionally printed articles. Accordingly, there is also a need for filaments suitable for three-dimensional printing which, in particular, address ecological requirements. Likewise, there is a need for three-dimensionally printed articles which, in particular, address ecological requirements. It is thus also an object of the invention to provide such a filament suitable for three-dimensional printing. Also, it is an object of the invention to provide such a three-dimensionally printed article.

### SUMMARY

This object is accomplished by the fiber, the yarn, the clothing and the methods having the features of the independent claims.

In a first aspect, the present invention relates to a fiber being made from a mixture comprising an aliphatic polyester, an aliphatic-aromatic polyester, and a polyhydroxyalkanoate.

In a second aspect, the present invention relates to a yarn comprising a fiber of the invention.

In a third aspect, the present invention relates to a textile comprising a fiber of the invention or a yarn of the invention.

In a fourth aspect, the present invention relates to a method of preparing a fiber according to the invention, comprising:
spinning a melt comprising an aliphatic polyester, an aliphatic-aromatic polyester, and a polyhydroxyalkanoate through a spinning nozzle to obtain a precursor fiber; and
cooling the precursor fiber, thereby obtaining the fiber.

In a fifth aspect, the present invention relates to the use of a melt comprising an aliphatic polyester, an aliphatic-aromatic polyester, and a polyhydroxyalkanoate for the preparation of a fiber, wherein the fiber is as defined herein.

In a sixth aspect, the present invention relates to the use of a melt comprising an aliphatic polyester, an aliphatic-aromatic polyester, and a polyhydroxyalkanoate for the preparation of a fiber.

In a seventh aspect, the present invention relates to the use of a mixture comprising an aliphatic polyester, an aliphatic-aromatic polyester, and a polyhydroxyalkanoate for the preparation of a fiber, wherein the fiber is as defined herein.

In an eighth aspect, the present invention relates to the use of a mixture comprising an aliphatic polyester, an aliphatic-aromatic polyester, and a polyhydroxyalkanoate for the preparation of a fiber.

The object of the invention is also accomplished by the filament suitable for three-dimensional printing, the roll comprising the filament, the cartridge suitable for a three-dimensional printer, the three-dimensionally printed article and the methods having the features of the independent claims.

In a ninth aspect, the present invention relates to a filament suitable for three-dimensional printing being made from a mixture comprising an aliphatic polyester, an aliphatic-aromatic polyester, and a polyhydroxyalkanoate.

In a tenth aspect, the present invention relates to a roll comprising a filament suitable for three-dimensional printing according to the invention.

In an eleventh aspect, the present invention relates to a cartridge suitable for a three-dimensional printer, comprising a filament suitable for three-dimensional printing of the invention.

In a twelfth aspect, the present invention relates to a three-dimensionally printed article, obtainable or being obtained by subjecting a filament suitable for three-dimensional printing of the invention to three-dimensional printing.

In a thirteenth aspect, the present invention relates to a method of preparing a filament suitable for three-dimensional printing according to the invention, comprising extruding a melt comprising an aliphatic polyester, an aliphatic-aromatic-polyester, and a polyhydroxyalkanoate into the form of a filament.

In a fourteenth aspect, the present invention relates to a use of a melt comprising an aliphatic polyester, an aliphatic-aromatic polyester, and a polyhydroxyalkanoate for the preparation of a filament suitable for three-dimensional printing, wherein the filament is as defined herein.

In a fifteenth aspect, the present invention relates to a use of a melt comprising an aliphatic polyester, an aliphatic-aromatic polyester, and a polyhydroxyalkanoate for the preparation of a filament suitable for three-dimensional printing.

In a fourteenth aspect, the present invention relates to a use of a mixture comprising an aliphatic polyester, an aliphatic-aromatic polyester, and a polyhydroxyalkanoate for the preparation of a filament suitable for three-dimensional printing, wherein the filament is as defined herein.

In a fifteenth aspect, the present invention relates to a use of a mixture comprising an aliphatic polyester, an aliphatic-aromatic polyester, and a polyhydroxyalkanoate for the preparation of a filament suitable for three-dimensional printing.

### BRIEF DESCRIPTION OF THE DRAWINGS

The invention will be better understood with reference to the detailed description when considered in conjunction with the non-limiting examples and the drawings, in which:

FIG. 1 shows a schematic representation of a melt spinning apparatus for preparing a fiber according to an embodiment of the invention.

FIG. 2 shows a schematic representation of a production process of a fiber which includes further treatment of the fiber on a fiber after treatment line according to an embodiment of the invention.

FIG. 3 is a photograph which shows granules of a mixture that can be used for preparing a fiber or a filament suitable for injection molding in accordance with the invention, fibers in accordance with embodiments of the invention, a yarn made from the fiber, and shirts which have been manufactured using a fiber according to an embodiment of the invention (in particular a yarn made from the fiber). FIG. 3 also shows a filament suitable for three-dimensional printing in accordance with an embodiment of the invention.

FIG. 4 is a photograph which shows further views of the shirts, which have been manufactured using the fiber according to an embodiment of the invention, in particular a yarn made from the fiber.

### DETAILED DESCRIPTION

### Fiber

As set out above, in a first aspect the present invention relates to a fiber being made from a mixture comprising an aliphatic polyester, an aliphatic-aromatic polyester, and a polyhydroxyalkanoate.

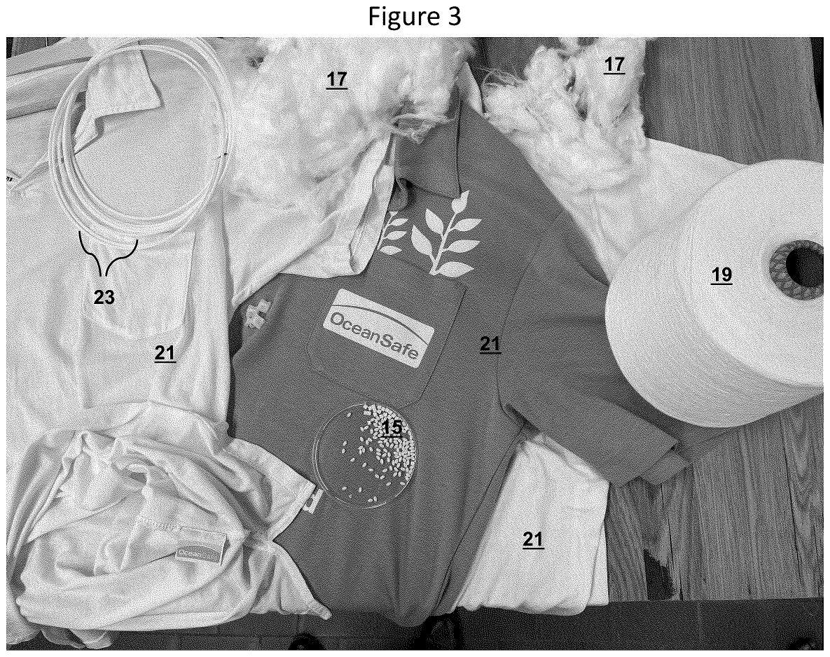

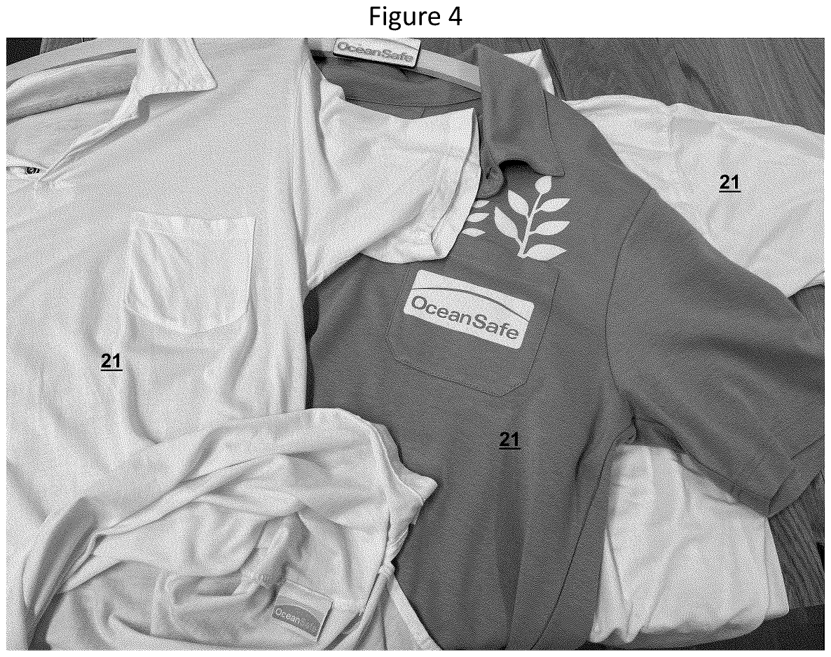

It has been found that a mixture comprising an aliphatic polyester, an aliphatic-aromatic polyester and a polyhydroxyalkanoate is well suited for preparing a fiber. In particular, a fiber comprising an aliphatic polyester, an aliphatic-aromatic polyester and a polyhydroxyalkanoate can be obtainable or can be obtained by melt spinning a mixture comprising an aliphatic polyester, an aliphatic-aromatic polyester and a polyhydroxyalkanoate. In this regard, it has been found that a mixture comprising an aliphatic polyester, an aliphatic-aromatic polyester and a polyhydroxyalkanoate exhibits good spinnability which is useful for melt spinning. It has also turned out that a fiber comprising an aliphatic polyester, an aliphatic-aromatic polyester and a polyhydroxyalkanoate exhibits good properties for use a textile fiber, such as, for example, good mechanical strength, elongation, flexibility, elasticity and wear resistance. As a further advantage, at the same time the preparation of the fiber requires a much lower water and land consumption than cotton (see Example 3). As yet a further advantage, the production of the fiber can be carried out without toxic substances, such as e.g. antimony (see Example 2). Further, by using an aliphatic polyester, an aliphatic-aromatic polyester, and a polyhydroxyalkanoate, a fiber can be obtained which is biodegradable and even meets the harmonized European standard EN 13432 and can thus be treated in industrial composting plants. Fibers of the invention can be used as textile fibers, e.g. for producing clothing such as a shirt (see Example 4 and FIGS. 3 and 4). It has been found that such clothing is biodegradable even to such an extent that such a piece of clothing is fully degraded/decomposed within only a couple of weeks after being put into organic waste. In this context it is noted that various products, such as e.g. plates, foils and also fibers, which comprise one or more of an aliphatic polyester, aliphatic-aromatic polyester, and/or a polyhydroxyalkanoate are described, e.g., in EP 3 626 767, WO 2010/034689, WO 2010/034711, WO 2015/169660, EP 1 966 419, EP 2 984 138, CN 103668540, CN 103668541, WO 2014/173055 and CN 104120502.

The term “aliphatic polyester” as used herein in general refers to a polyester which is typically synthesized through a condensation polymerization of an aliphatic diol and an aliphatic dicarboxylic acid or an anhydride thereof. As an illustrative example, the aliphatic polyester as used herein may comprise an aliphatic C₂-C₂₀ dicarboxylic acid and an aliphatic C₂-C₁₂ diol. Preferably, the aliphatic diol is an aliphatic C₂-C₈ diol. More preferably, the aliphatic diol is an aliphatic C₂-C₆ diol. Even more preferably, the aliphatic diol is an aliphatic C₃ diol or an aliphatic C₄ diol. Aliphatic diols used in the aliphatic polyester may include, as illustrative examples, ethylene glycol, propylene glycol, 1,3-propanediol, 1,3-butanediol, 1,4-butanediol, 1,5 pentanediol, and 1,6-hexanediol. Preferably, the aliphatic diol is 1,3-propanediol or 1,4-butanediol. More preferably, the aliphatic diol is 1,4-butanediol. Preferably, the aliphatic dicarboxylic acid is an aliphatic C₂-C₁₂ dicarboxylic acid. More preferably, the aliphatic dicarboxylic acid is an aliphatic C₂-C₈ dicarboxylic acid, even more preferably an aliphatic C₄ dicarboxylic acid. Aliphatic dicarboxylic acids used in the aliphatic polyester may include, as illustrative examples, oxalic acid, malonic acid, succinic acid, glutaric acid, and adipic acid. Preferably, the aliphatic dicarboxylic acid is malonic acid or succinic acid. More preferably, the aliphatic dicarboxylic acid is succinic acid. Optionally, when the dicarboxylic acid is an aliphatic C₂-C₁₂ dicarboxylic acid, the aliphatic polyester may further comprise an additional aliphatic C₆-C₂₀ dicarboxylic acid, which is different from the C₂-C₁₂ dicarboxylic acid. The optional aliphatic C₆-C₁₂ dicarboxylic acids may include, as illustrative examples, adipic acid, suberic acid, azelaic acid, sebacic acid, brassylic acid and arachidonic acid. Preferably, the optional aliphatic C₆-C₁₂ dicarboxylic acids may include adipic acid, suberic acid, azelaic acid, sebacic acid and brassylic acid. The optional aliphatic C₂-C₁₂ dicarboxylic acid may be present in the aliphatic polyester at a ratio of from 0 to 10 mol-%, based on 100 mol-% of the total amount of aliphatic dicarboxylic acids in the aliphatic polyester. Optionally, the aliphatic polyester may further comprise a chain extender and/or a branching agent. Optional chain extenders and/or branching agents may include, as illustrative examples, a polyfunctional isocyanate, isocyanurate, oxazoline, carboxylic anhydride such as e.g. maleic anhydride, epoxide (in particular an epoxy-containing poly(meth)acrylate), an at least trihydric alcohol, and an at least tribasic carboxylic acid. The optional chain extender and/or branching agent may be present in the aliphatic polyester at a ratio of from 0 to 1% by weight based on 100% by weight of the combined amount of aliphatic dicarboxylic acid(s) and aliphatic diol. The term “aliphatic polyester” may also include a mixture of two or more different aliphatic polyesters. The aliphatic polyester may have a number average molecular weight (Mn) ranging from 2,500 to 150,000 g/mol, preferably from 5,000 to 100,000 g/mol, more preferably from 7,500 to 75,000 g/mol, still more preferably from 10,000 to 65,000 g/mol, even more preferably from 12,000 to 60,000 g/mol. The aliphatic polyester may have a weight average molecular weight (Mw) ranging from 5,000 to 300,000 g/mol, preferably from 10,000 to 250,000 g/mol, more preferably from 20,000 to 220,000 g/mol, still more preferably from 50,000 to 200,000 g/mol, even more preferably from 60,000 to 190,000 g/mol. The aliphatic polyester may have a polydispersity index (i.e. the ratio of the weight average molecular weight to the number average molecular weight (Mw/Mn)) ranging from 1 to 6, preferably from 1 to 4, more preferably from 1.0 to 3.0, still more preferably from 1.2 to 2.0, even more preferably from 1.4 to 1.8.

Illustrative examples of aliphatic polyesters, which can be used in the present invention, may include an aliphatic polyester selected from the group consisting of a polybutylene succinate (PBS), a polyethylene oxalate, a polyethylene malonate, a polyethylene succinate, a polypropylene oxalate, a polypropylene malonate, a polypropylene succinate, a polybutylene oxalate, a polybutylene malonate, a polybutylene succinate-co-adipate (PBSA), a polybutylene succinate-co-azelate (PBSAz), a polybutylene succinate-co-brassylate (PBSBr), and any combination thereof. The aliphatic polyester may preferably be selected from the group consisting of a polybutylene succinate (PBS), a polybutylene succinate-co-adipate (PBSA), a polybutylene succinate-co-azelate (PBSAz), a polybutylene succinate-co-brassylate (PBSBr), and any combination thereof. In one preferred embodiment, the aliphatic polyester is a polybutylene succinate. The term “polybutylene succinate” as used herein in particular denotes a condensation product from the aliphatic dicarboxylic acid succinic acid and the aliphatic diol 1,4-butanediol. The aliphatic polyesters polybutylene succinate (PBS) and polybutylene succinate-co-adipate (PBSA) are commercially available, for example, from Showa Highpolymer as Blanche®, and by Mitsubishi as GSPIa®. The aliphatic polyester, in particular polybutylene succinate (PBS), may be obtained from renewable resources or from fossil resources. Preferably, an aliphatic polyester from renewable resources is used. More preferably, bio-based polybutylene succinate (PBS) produced from bio-based succinic acid and 1,4-butanediol, which is e.g. commercially available from Mitsubishi Chemicals under the tradename BioPBS™ FZ71, can be used. Preferably, the aliphatic polyester is biodegradable. In particular, polybutylene succinate (PBS) is a biodegradable aliphatic polyester.

Preferably, the fiber comprises the aliphatic polyester in an amount of from 30 to 70% by weight, based on 100% by weight of the combined amount of the aliphatic polyester, the aliphatic-aromatic polyester, and the polyhydroxyalkanoate. More preferably, the fiber comprises the aliphatic polyester in an amount of from 35 to 65% by weight, based on 100% by weight of the combined amount of the aliphatic polyester, the aliphatic-aromatic polyester, and the polyhydroxyalkanoate. Still more preferably, the fiber comprises the aliphatic polyester in an amount of from 40 to 60% by weight or 42 to 62% by weight, based on 100% by weight of the combined amount of the aliphatic polyester, the aliphatic-aromatic polyester, and the polyhydroxyalkanoate. Even more preferably, the fiber comprises the aliphatic polyester in an amount of from 45 to 55% by weight, based on 100% by weight of the combined amount of the aliphatic polyester, the aliphatic-aromatic polyester, and the polyhydroxyalkanoate. In particular, these ranges can be applied when the aliphatic polyester is a polybutylene succinate. In a preferred embodiment, the fiber comprises 52% by weight of a polybutylene succinate based on 100% by weight of the combined amount of the polybutylene succinate, an aliphatic aromatic polyester and a polyhydroxyalkanoate.

The term “aliphatic-aromatic polyester” as used herein in general refers to a polyester which is typically synthesized from an aliphatic diol, an aliphatic dicarboxylic acid and an aromatic dicarboxylic acid. As an illustrative example, the aliphatic-aromatic polyester may comprise an aliphatic C₂-C₂₀ dicarboxylic acid, an aromatic dicarboxylic acid and an aliphatic C₂-C₁₂ diol. Preferably, the aliphatic diol is an aliphatic C₂-C₈ diol. More preferably, the aliphatic diol is an aliphatic C₂-C₆ diol. Even more preferably, the aliphatic diol is an aliphatic C₃ diol or an aliphatic C₄ diol. Aliphatic diols used in the aliphatic-aromatic polyester may include, as illustrative examples, ethylene glycol, propylene glycol, 1,3-propanediol, 1,3-butanediol, 1,4-butanediol, 1,5 pentanediol, and 1,6-hexanediol. Preferably, the aliphatic diol is 1,3-propanediol or 1,4-butanediol. More preferably, the aliphatic diol is 1,4-butanediol. Preferably, the aliphatic dicarboxylic acid is an aliphatic C₂-C₁₂ dicarboxylic acid. More preferably, the aliphatic dicarboxylic acid is an aliphatic C₄-C₁₀ dicarboxylic acid, even more preferably an aliphatic C₆ dicarboxylic acid. Aliphatic dicarboxylic acids used in the aliphatic-aromatic polyester may include, as illustrative examples, glutaric acid, adipic acid, pimelic acid, azelaic acid, sebacic acid, brassylic acid, suberic acid, and itaconic acid. Preferably, the aliphatic dicarboxylic acid is adipic acid, azelaic acid, or sebacic acid. More preferably, the aliphatic dicarboxylic acid is adipic acid. Preferably, the aromatic dicarboxylic acid is terephthalic acid. The aromatic dicarboxylic acid, in particular terephthalic acid, may be present in the aliphatic-aromatic polyester in an amount of e.g. from 30 to 70 mol-%, preferably of from 40 to 60 mol-%, more preferably of from 40 to 55 mol-%, each based on 100 mol-% of the combined amount of the aliphatic dicarboxylic acid and the aromatic dicarboxylic acid. Optionally, the aliphatic polyester may further comprise a chain extender and/or a branching agent. Optional chain extenders may include, as illustrative examples, a di- or polyfunctional isocyanate, preferably hexamethylenediisocyanate. Optional branching agents may include, as illustrative examples, trimethylolpropane, pentaerythritol, and preferably glycerol. The optional chain extender and/or branching agent may be present in the aliphatic polyester at a ratio of from 0 to 1% by weight based on 100% by weight of the combined amount of the aliphatic dicarboxylic acid, the aromatic dicarboxylic acid, and the aliphatic diol. The term “aliphatic-aromatic polyester” may also include a mixture of two or more different aliphatic-aromatic polyesters. The aliphatic-aromatic polyester may have a number average molecular weight (Mn) ranging from 1,000 to 500,000 g/mol, preferably from 5,000 to 300,000 g/mol, more preferably from 5,000 to 100,000 g/mol, still more preferably from 10,000 to 75,000 g/mol, even more preferably from 15,000 to 50,000 g/mol. The aliphatic-aromatic polyester may have a weight average molecular weight (Mw) ranging from 10,000 to 500,000 g/mol, preferably from 20,000 to 400,000 g/mol, more preferably from 30,000 to 300,000 g/mol, still more preferably from 60,000 to 200,000 g/mol. The aliphatic-aromatic polyester may have a polydispersity index (i.e. the ratio of the weight average molecular weight to the number average molecular weight (Mw/Mn)) ranging from 1 to 6, preferably from 2 to 4, more preferably from 1.0 to 3.0, still more preferably from 1.2 to 2.0, even more preferably from 1.4 to 1.8.

Aliphatic-aromatic polyesters, which can be used in the present invention, may include, but are not limited to, an aliphatic-aromatic polyester selected from the group consisting of a polybutylene adipate terephthalate (PBAT), a polybutylene succinate terephthalate (PBST), a polybutylene sebacate terephthalate (PBSeT), and any combination thereof. In one preferred embodiment, the aliphatic-aromatic polyester is a polybutylene adipate terephthalate (PBAT). The term “polybutylene adipate terephthalate” as used herein denotes an aliphatic-aromatic polyester which comprises the aliphatic dicarboxylic acid adipic acid, the aromatic dicarboxylic acid terephthalic acid, and the aliphatic diol 1,4-butanediol. The aliphatic-aromatic polyester, in particular polybutylene adipate terephthalate (PBAT), may be obtained from renewable resources or from fossil resources. Preferably, an aliphatic-aromatic polyester from renewable resources is used. Polybutylene adipate terephthalate (PBAT) is marketed, for example, by BASF as Ecoflex®, e.g. Ecoflex® F Blend C1200 or Ecoflex® FBX 7011, or by Showa Denko as Bionolle®. Preferably, the aliphatic-aromatic polyester is biodegradable. In particular, polybutylene adipate terephthalate (PBAT) is a biodegradable aliphatic-aromatic polyester.

Preferably, the fiber comprises the aliphatic-aromatic polyester in an amount of from 10 to 60% by weight, based on 100% by weight of the combined amount of the aliphatic polyester, the aliphatic-aromatic polyester, and the polyhydroxyalkanoate. More preferably, the fiber comprises the aliphatic-aromatic polyester in an amount of from 20 to 50% by weight, based on 100% by weight of the combined amount of the aliphatic polyester, the aliphatic-aromatic polyester, and the polyhydroxyalkanoate. Still more preferably, the fiber comprises the aliphatic-aromatic polyester in an amount of from 25 to 40% by weight or 26 to 46% by weight, based on 100% by weight of the combined amount of the aliphatic polyester, the aliphatic-aromatic polyester, and the polyhydroxyalkanoate. Even more preferably, the fiber comprises the aliphatic-aromatic polyester in an amount of from 30 to 40% by weight, based on 100% by weight of the combined amount of the aliphatic polyester, the aliphatic-aromatic polyester, and the polyhydroxyalkanoate. In particular, these ranges can be applied when the aliphatic-aromatic polyester is a polybutylene adipate terephthalate (PBAT). In a preferred embodiment, the fiber comprises 36% by weight polybutylene adipate terephthalate (PBAT) based on 100% by weight of the combined amount of an aliphatic polyester, the polybutylene adipate terephthalate (PBAT) and a polyhydroxyalkanoate.

The term “polyhydroxyalkanoate” as used herein in general refers to a polyester from hydroxyalkane carboxylic acid monomers. Polyhydroxyalkanoates can be produced by numerous microorganisms, including through bacterial fermentation of sugars or lipids. Preferably, the hydroxyalkane carboxylic acid is a C₄-C₁₈ hydroxyalkane carboxylic acid, i.e. preferably the hydroxyalkane carboxylic acid comprises 4 to 18 carbon atoms. More preferably, the polyhydroxyalkanoate comprises monomeric units having the following formula (I):

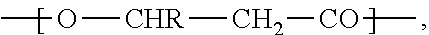

wherein R is an alkyl group having the formula CₙH₂ₙ₊₁, and n is an integer of from 1 to 15, preferably of from 1 to 6. In some embodiments, the polyhydroxyalkanoate is a homopolymer. In some preferred embodiments, the polyhydroxyalkanoate is a copolymer. When the polyhydroxyalkanoate is a copolymer, the copolymer may comprise two different monomeric units of formula (I). The term “polyhydroxyalkanoate” may also include a mixture of two or more different polyhydroxyalkanoates. The polyhydroxyalkanoate may have a weight average molecular weight (Mw) ranging from 70,000 to 1,000,000 g/mol, preferably from 100,000 to 1,000,000 g/mol, more preferably from 300,000 to 600,000 g/mol.

Illustrative examples of polyhydroxyalkanoates, which can be used in the present disclosure, may include a polyhydroxyalkanoate selected from the group consisting of a polyhydroxybutyrate, a polyhydroxyvalerate, a polyhydroxybutyrate-co-hydroxyvalerate, a polyhydroxybutyrate-co-hydroxyhexanoate, and any combination thereof. Preferably, the polyhydroxyalkanoate is selected from the group consisting of a poly-3-hydroxybutyrate (P3HB), a poly-4-hydroxybutyrate (P4HB), a poly-3-hydroxyvalerate (PHV), a poly(3-hydroxybutyrate-co-4-hydroxybutyrate), a poly(3-hydroxybutyrate-co-3-hydroxyvalerate) (PHBV), a poly(3-hydroxybutyrate-co-3-hydroxyhexanoate) (PHBH), and any combination thereof. Still more preferably, the polyhydroxyalkanoate is selected from the group consisting of a poly-3-hydroxybutyrate (PHB)

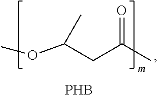

a poly(3-hydroxybutyrate-co-3-hydroxyvalerate) (PHBV)

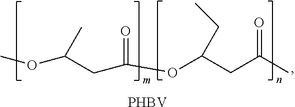

and
a poly(3-hydroxybutyrate-co-3-hydroxyhexanoate) (PHBH)

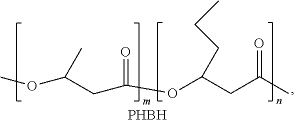

and
any combination thereof. Even more preferably, the polyhydroxyalkanoate is a polyhydroxybutyrate-co-hydroxyhexanoate. In a very preferred embodiment, the polyalkoxyalkanoate is a poly(3-hydroxybutyrate-co-3-hydroxyhexanoate) (PHBH). Preferably, the molar ratio m:n in the foregoing structural formulae is of from 95:5 to 85:15, more preferably of from 90:10 to 88:12. Preferably, a poly(3-hydroxybutyrate-co-3-hydroxyhexanoate) (PHBH) having a molar ratio of 3-hydroxyhexanoate of from 5 to 15 mol-%, preferably of from 7 to 13 mol-%, more preferably of from 10 to 13 mol-%, each based on 100 mol-% of the total amount of monomers in the poly(3-hydroxybutyrate-co-3-hydroxyhexanoate) (PHBH), is used. Poly(3-hydroxybutyrate-co-3-hydroxyhexanoate) (PHBH) is marketed by way of example by P&G or Kaneka. The polyhydroxyalkanoate, in particular poly(3-hydroxybutyrate-co-3-hydroxyhexanoate) (PHBH), may be obtained from renewable resources or fossil resources. Preferably, a polyhydroxyalkanoate from renewable resources is used. More preferably, bio-based poly(3-hydroxybutyrate-co-3-hydroxyhexanoate) (PHBH), which is e.g. commercially available from Kaneka under the tradename AONILEX X 151 A, can be used. Preferably, the polyhydroxyalkanoate is biodegradable. In particular, poly(3-hydroxybutyrate-co-3-hydroxyhexanoate) (PHBH) is a biodegradable polyhydroxyalkanoate.

Preferably, the fiber comprises the polyhydroxyalkanoate in an amount of from 1 to 25% by weight, based on 100% by weight of the combined amount of the aliphatic polyester, the aliphatic-aromatic polyester, and the polyhydroxyalkanoate. More preferably, the fiber comprises the polyhydroxyalkanoate in an amount of from 2 to 22% by weight, based on 100% by weight of the combined amount of the aliphatic polyester, the aliphatic-aromatic polyester, and the polyhydroxyalkanoate. Still more preferably, the fiber comprises the polyhydroxyalkanoate in an amount of 3 to 20 by weight, based on 100% by weight of the combined amount of the aliphatic polyester, the aliphatic-aromatic polyester, and the polyhydroxyalkanoate. Still more preferably, the fiber comprises the polyhydroxyalkanoate in an amount of from 3 to 18% by weight, based on 100% by weight of the combined amount of the aliphatic polyester, the aliphatic-aromatic polyester, and the polyhydroxyalkanoate. Even more preferably, the fiber comprises the polyhydroxyalkanoate in an amount of from 5 to 15% by weight, based on 100% by weight of the combined amount of the aliphatic polyester, the aliphatic-aromatic polyester, and the polyhydroxyalkanoate. In particular, these ranges can be applied when the polyhydroxyalkanoate is a polyhydroxybutyrate-co-hydroxyhexanoate, preferably a poly(3-hydroxybutyrate-co-3-hydroxyhexanoate) (PHBH). Preferably, when the polyhydroxyalkanoate is a polyhydroxybutyrate-co-hydroxyhexanoate, preferably a poly(3-hydroxybutyrate-co-3-hydroxyhexanoate) (PHBH), the fiber comprises 20% by weight or less, more preferably 18% by weight or less of the polyhydroxybutyrate-co-hydroxyhexanoate, preferably the poly(3-hydroxybutyrate-co-3-hydroxyhexanoate) (PHBH) based on 100% by weight of the combined amount of an aliphatic polyester, an aliphatic-aromatic polyester and the polyhydroxybutyrate-co-hydroxyhexanoate, preferably the poly(3-hydroxybutyrate-co-3-hydroxyhexanoate) (PHBH). If the ratio of the polyhydroxybutyrate-co-hydroxyhexanoate, preferably the poly(3-hydroxybutyrate-co-3-hydroxyhexanoate) (PHBH) exceeds 18% by weight, achieving the EN 13432 standard for biodegradability without pre-composting or industrial composting may become difficult, when exceeding 20% by weight still more difficult. In a preferred embodiment, the fiber comprises 12% by weight poly(3-hydroxybutyrate-co-3-hydroxyhexanoate) (PHBH) based on 100% by weight of the combined amount of a polybutylene succinate, a polybutylene adipate terephthalate and a poly(3-hydroxybutyrate-co-3-hydroxyhexanoate) (PHBH).

In one very preferred embodiment, the aliphatic polyester is a polybutylene succinate (PBS), the aliphatic-aromatic polyester is a polybutylene adipate terephthalate (PBAT), and the polyalkoxyalkanoate is a poly(3-hydroxybutyrate-co-3-hydroxyhexanoate) (PHBH). Accordingly, in one very preferred embodiment, the fiber comprises a polybutylene succinate (PBS), a polybutylene adipate terephthalate (PBAT), and a poly(3-hydroxybutyrate-co-3-hydroxyhexanoate) (PHBH).

The ranges for the amounts of the aliphatic polyester, the aliphatic-aromatic polyester and the polyhydroxyalkanoate may be also combined with each other. Accordingly, as illustrative examples, the fiber may comprise the aliphatic polyester in an amount of from 42 to 62% by weight, preferably 45 to 55% by weight, the fiber may comprise the aliphatic-aromatic polyester in an amount of from 26 to 46% by weight, preferably 30 to 40% by weight, and the fiber may comprise the polyhydroxyalkanoate in an amount of from 2 to 22% by weight, preferably 3 to 20% by weight, more preferably 3 to 18% by weight, each based on 100% by weight of the combined amount of the aliphatic polyester, the aliphatic-aromatic polyester and the polyhydroxyalkanoate. A person skilled in the art will readily select suitable amounts of one or more of the polymer(s) within the ranges provided herein, so that the total amount of 100% by weight of the combined amount of the aliphatic polyester, the aliphatic-aromatic polyester and the polyhydroxyalkanoate is not exceeded. In particular, these ranges can be applied when the aliphatic polyester is a polybutylene succinate, the aliphatic aromatic polyester is a polybutylene adipate terephthalate, and the polyhydroxyalkanoate is a polyhydroxybutyrate-co-hydroxyhexanoate, preferably a poly(3-hydroxybutyrate-co-3-hydroxyhexanoate) (PHBH). In a very preferred embodiment, the fiber comprises 52% by weight of a polybutylene succinate, 36% by weight of a polybutylene adipate terephthalate and 12% by weight of a polyhydroxybutyrate-co-hydroxyhexanoate, preferably a poly(3-hydroxybutyrate-co-3-hydroxyhexanoate) (PHBH), each based on 100% by weight of the combined amount of the polybutylene succinate, the polybutylene adipate terephthalate and the polyhydroxybutyrate-co-hydroxyhexanoate, preferably the poly(3-hydroxybutyrate-co-3-hydroxyhexanoate) (PHBH).

In some embodiments, the polyhydroxyalkanoate may be partially or totally replaced by a polylactide (PLA, or also known as polylactic acid or poly(lactic acid)). Accordingly, in some embodiments, when the polyhydroxyalkanoate is partially replaced by a polylactide, the fiber comprises the aliphatic polyester, the aliphatic-aromatic polyester, the polyhydroxyalkanoate, and a polylactide. In some embodiments, when the polyhydroxyalkanoate is totally replaced by a polylactide, the fiber comprises the aliphatic polyester, the aliphatic-aromatic polyester, and the polylactide. However, in embodiments where the polyhydroxyalkanoate is totally replaced by a polylactide, the fiber does not contain a polyhydroxyalkanoate.

Preferably, the fiber is a textile fiber. The term “textile fiber”, as used herein, in general refers to a fiber which is suitable for producing a textile. As illustrative non-limiting examples, a textile fiber may be suitable for preparing a yarn, a textile or a textile surface.

Optionally, the fiber may further comprise at least one additive (one or more additives). For example, the fiber may comprise at least one additive (or one or more additives) that is generally known to be used in a textile fiber. The optional additives may include, but are not limited to, additives such as a flame retardant, a matting agent, a marker for authentication (e.g., a fluorescence marker), an antimicrobial agent, a colorant, a plasticizer, a filler, and any combination thereof.

Preferably, the fiber further comprises a flame retardant, for example, a flame retardant such as a phosphate. The term “phosphate” as used herein refers to a salt comprising an anion selected from the group consisting of [H₂PO₄]⁻, [HPO₄]²⁻ and [PO₄]³⁻.

Preferably, the cation is ammonium [NH₄]⁺. Accordingly, in preferred embodiments, the flame retardant is selected from the group consisting of ammonium dihydrogenphosphate ([NH₄][H₂PO₄]), di-ammonium hydrogenphosphate ([NH₄]₂[HPO₄]), triammonium phosphate ([NH₄]₃[PO₄]) and any combination thereof. More preferably, the flame retardant is selected from the group consisting of ammonium dihydrogenphosphate ([NH₄][H₂PO₄]), di-ammonium hydrogenphosphate ([NH₄]₂[HPO₄]) and any combination thereof. More preferably, the flame retardant is ammonium dihydrogenphosphate ([NH₄][H₂PO₄]) or di-ammonium hydrogenphosphate ([NH₄]₂[HPO₄]). Still more preferably, the flame retardant is di-ammonium hydrogenphosphate ([NH₄]₂[HPO₄]). Alternatively, or in addition, the flame retardant may be a polyphosphate. “Polyphosphates” are salts or esters of polymeric oxyanions formed from tetrahedral PO₄ (phosphate) structural units linked together by sharing oxygen atoms. Preferably, when the flame retardant is a polyphosphate, the flame retardant is ammonium polyphosphate.

The fiber may comprise the flame retardant in an amount of from 0.01 to 5% by weight, based on 100% by weight on the total weight of the fiber. Preferably, the fiber comprises the flame retardant in an amount of from 0.1 to 4% by weight, based on 100% by weight of the total weight of the fiber. More preferably, the fiber comprises the flame retardant in an amount of from 0.2% to 3% by weight, based on 100% by weight of the total weight of the fiber. Still more preferably, the fiber comprises the flame retardant in an amount of from 0.3 to 3% by weight, based on 100% by weight of the total weight of the fiber. Even more preferably, the fiber comprises the flame retardant in an amount of from 0.3 to 2% by weight, based on 100% by weight of the total weight of the fiber. In particular, the foregoing ranges can be applied when the flame retardant is a phosphate or a polyphosphate, preferably, when the flame retardant is di-ammonium hydrogenphosphate ([NH₄]₂[HPO₄]).

Optionally, the fiber may (also) comprise a matting agent. Any matting agent known to a person skilled in the art can be used, such as a typical matting agent used in fibers. As illustrative example, the matting agent may be zinc sulfide.

Optionally, the fiber may (also) comprise a marker suitable for authentication. As an illustrative non-limiting example, the marker suitable for authentication can be a fluorescence marker. Fluorescence of the fiber can then be detected by a suitable device and taken for authentication of the fiber. For example, a fluorescence marker available from Polysecure, Freiburg im Breisgau, Germany can be used. The marker suitable for authentication is generally used only in small amounts, which usually do not alter the properties of the fiber. Typically, the amount of the marker suitable for authentication in the fiber is in the ppb (parts per billion) range.

Optionally, the fiber may (also) include an antimicrobial agent. Any antimicrobial agent known to a person skilled in the art, which is suitable for being used in a fiber, can be used. As an illustrative non-limiting example, the antimicrobial agent may be zinc encapsulated with polyethylene terephthalate. Such antimicrobial agent, e.g., is commercially available from Smartpolymer GmbH, Rudolstadt, Germany, under the trade name SMARTZINC 213 PET Hot Melt.

Optionally, the fiber may (also) include a plasticizer. Any plasticizer known to a person skilled in the art, which is suitable for being used in a fiber, can be used. As an illustrative example, the plasticizer may be polycaprolactone. In particular, polycaprolactone is biodegradable. In some embodiments, the fiber may comprise polycaprolactone in an amount of 1% by weight or less based on 100% by weight of the total weight of the fiber. It has turned out that a fiber comprising 1% by weight or less of polycaprolactone exhibits satisfactory softness and flexibility. However, it is noted that a fiber in accordance with the present invention, which comprises an aliphatic polyester, an aliphatic-aromatic polyester and a polyhydroxyalkanoate, may usually already exhibit satisfactory softness and flexibility without addition of polycaprolactone or other plasticizers.

Optionally, the fiber may (also) include a colorant. Any colorant providing a desired color, which is suitable for being used in a fiber, may be used. As illustrative examples, the colorant may be an inorganic or an organic pigment.

Optionally, the fiber may (also) include a filler. Any filler known to a person skilled in the art, which is suitable for being used in a fiber, may be used, with biodegradable fillers being preferred. As illustrative example, the (biodegrable) filler may be lignin or may comprise lignin. Preferably, the lignin is oxygen-bleached lignin. Oxygen-bleaching of lignin is an environmentally friendly process, compared to traditional chlorine bleaching.

A person skilled in the art will readily select suitable amount(s) of the additive(s) to be comprised in the fiber. As an illustrative example, the fiber may comprise a total amount of additive(s) of 15% by weight or less, based on 100% by weight of the total weight of the fiber. The fiber may comprise a total amount of additive(s) of 10% by weight or less, based on 100% by weight of the total weight of the fiber. Preferably, the fiber comprises a total amount of additives of 7% by weight or less, based on 100% by weight of the total weight of the fiber. More preferably, the fiber comprises a total amount of additives of 5% by weight or less, based on 100% by weight of the total weight of the fiber. Still more preferably, the fiber comprises a total amount of additives of 4% by weight or less, based on 100% by weight of the total weight of the fiber. Even more preferably, the fiber comprises a total amount of additives of 3 to 4% by weight, based on 100% by weight of the total weight of the fiber. It is preferred that the fiber comprises a total amount of additives of 7% by weight or less, more preferably 3 to 4% by weight, each based on 100% by weight of the total weight of the fiber, in order to achieve a stiffness of the fiber which is useful for a textile fiber.

The fiber titer is not particularly limited. For example, any fiber titer which is commonly used in the textile industry can be applied. As an illustrative example, the fiber titer may be 0.5 to 8 den. Preferably, the fiber titer is 0.8 to 6 den. More preferably, the fiber titer 0.9 to 3 den. Still more preferably, the fiber titer is 1.0 to 2 den. Still more preferably, the fiber titer is 1.0 to 1.5 den. Even more preferably, the fiber titer is 1.1 to 1.2 den.

The fiber may be a staple fiber. The term “staple fiber” as used herein in general refers to fibers of discrete length. The staple length is not particularly limited. For example, any stable length which is commonly used in the textile industry can be applied. Accordingly, as an illustrative example, the fiber may have a staple length of from 2 to 80 mm. Preferably, the fiber has staple length of from 5 to 70 mm. More preferably, the fiber has a staple length of from 10 to 60 mm. Still more preferably, the fiber has a staple length of from 15 to 50 mm. Even more preferably, the fiber has a staple length of from 20 to 40 mm. Even more preferably, the fiber has a staple length of from 22 to 35 mm. Even more preferably, the fiber has a staple length of from 25 to 32 mm. The term “staple length” in general refers to an average length of the fibers in a sample.

The fiber may be a filament. The term “filament” or “filament fiber” in general refers to a fiber of practically unlimited length. Accordingly, the term “filament” or “filament fiber” in general refers to a continuous fiber.

Preferably, the fiber is biodegradable. More preferably, the fiber is biodegradable in accordance with EN 13432. Accordingly, the fiber may be considered as biodegradable in accordance with EN 13432 when the fiber has a DIN EN 13432 percentage degree of biodegradation equal to at least 90% after the prescribed periods of time. The general effect of biodegradability is that the fiber decomposes within an appropriate and verifiable interval. Degradation may be effected enzymatically, hydrolytically, oxidatively and/or through action of electromagnetic radiation, for example UV radiation, and may be predominantly due to the action of microorganisms such as bacteria, yeasts, fungi and algae. Biodegradability can be quantified, for example, by the fiber being mixed with compost and stored for a certain time. For example, CO₂-free air can be flowed through ripened compost during composting and the ripened compost subjected to a defined temperature program. Biodegradability can be, for example, defined via the ratio of the net CO₂ released by the sample (after deduction of the CO₂ released by the compost without sample) to the maximum amount of CO₂ releasable by the sample (reckoned from the carbon content of the sample), as a percentage degree of biodegradation. A biodegradable fiber typically shows clear signs of degradation, such as fungal growth, cracking and holing, after just a few days of composting. Other methods of determining biodegradability are described, for example, in ASTM D 5338 and ASTM D 6400.

Preferably, the fiber is a crimped fiber.

Optionally, any fiber described herein may be subjected to a fiber after treatment, e.g. using a fiber aftertreatment line. After treatment may comprise steps conventionally used for treatment of a fiber, such as e.g. reed, intake structure, dipping, drafting, stretching, steaming, reviving, crimping, drying, and/or staple cutting.

In some embodiments, the fiber is not a hollow fiber. The term “hollow fiber”, as used herein and known in the art, in general refers to any fiber which has one or more cavities in cross section. The term “cavity”, as used herein, in general denotes a hollow space which is present within the cross section of the fiber. The cavity may be filled with gas, such as e.g. with air. As an illustrative example, the hollow fiber may have one continuous cavity in cross section. However, it is also possible that the hollow fiber comprises more than one cavity (e.g., 2, 3, 4, 5, 6, 7, 8, 9, 10, 11, 12, 13, 14, 15, 16, 17, 18, 19, 20 or even more cavities). The hollow fiber may, in addition to the one or more cavities, further comprise one or more portions having a compact structure. As used herein, the term “compact structure”, which may be also referred to as a “condensed structure”, in general denotes that the material of the fiber is present in a substantially dense or condensed form, in particular when compared to a cavity of the hollow fiber. The term “compact structure” or “condensed structure” may also include that the respective structure contains pore(s) which, however, are in general significantly smaller than a cavity of the hollow fiber. A hollow fiber which comprises both cavities and compact (or condensed) structures may be also denoted as a segmented fiber, or a segmented hollow fiber. As an illustrative example, the hollow fiber may comprise cavities and compact structures which are arranged in an alternating pattern along the longitudinal direction of the fiber.

In particular, in some embodiments, the fiber is a not a fiber as described in international patent application PCT/EP2022/075084. Fibers described in PCT/EP2022/075084 are also described in the following. Accordingly, in some embodiments, the fiber is not:
A fiber being obtainable or being obtained by a method comprising:
   spinning a melt comprising an aliphatic polyester, an aliphatic-aromatic polyester, and a polyhydroxyalkanoate through a hollow fiber spinning nozzle to obtain a precursor fiber; and
   cooling the precursor fiber under a temperature gradient, thereby obtaining the fiber.
A fiber obtainable or being obtained by this method comprises two kinds of portions, wherein the one kind of portions are thicker portions and the other kinds of portions are thinner portions, and has a structure as described herein in the following. Accordingly, in some embodiments, the fiber is not:
A fiber being made from a mixture comprising an aliphatic polyester, an aliphatic-aromatic polyester, and a polyhydroxyalkanoate,
wherein the fiber comprises, in a longitudinal direction, two kinds of portions, wherein the one kind of portions are thicker portions and the other kinds of portions are thinner portions, wherein said thicker portions and thinner portions extend in a vertical direction relative to the longitudinal direction of the fiber, and wherein an extension in the vertical direction of a thicker portion is greater than an extension in the vertical direction of a thinner portion;
wherein at least a part of the thicker portions has a cavity, and at least a part of the thinner portions has a compact structure. In some embodiments, the fiber is not:
A hollow fiber being made from a mixture comprising an aliphatic polyester, an aliphatic-aromatic polyester, and a polyhydroxyalkanoate. In some embodiments, the fiber is not a segmented fiber or a segmented hollow fiber.

In some embodiments, the fiber is a solid fiber. In some embodiments, the fiber is a non-hollow fiber. The term “solid fiber”, or also denoted as “non-hollow fiber”, as used herein and known in the art, in general refers to any fiber wherein the material of the fiber is present in a substantially dense or condensed form, and which has no cavities, as described herein for a hollow fiber. However, the term “solid fiber”, or “non-hollow fiber”, does not exclude that the fiber may contain a few pore(s) which, however, are in general significantly smaller than a cavity of a hollow fiber.

The present invention also relates to a yarn comprising a fiber as described herein. Any type of yarn may be considered. As non-illustrative examples, the yarn may be a spun yarn, a carded or combed yarn, a hosiery yarn, an open-end yarn, a novelty yarn, a filament yarn, or a texturized yarn. A yarn may be prepared from the fiber described herein by any method suitable for preparing a yarn. Methods for preparing a yarn are generally known and readily selected by a person skilled in the art.

The present invention also relates to a textile surface comprising a fiber as described herein. The present invention also relates to a textile surface comprising a yarn, said yarn comprising a fiber as described herein. As illustrative, non-limiting examples, the textile surface may be selected from the group consisting of a fabric, a knitted fabric, and non-wovens. The fiber or yarn comprising the fiber can be also used for preparing a fleece.

The present invention also relates to a textile comprising a fiber as described herein. The present invention also relates to a textile comprising a yarn, said yarn comprising a fiber as described herein. The textile may be a clothing. As illustrative, non-limiting examples, the clothing may be selected from the group consisting of a shirt, a polo shirt, a pair of trousers, a jacket, underwear, socks, a coat, a shoe and shoe laces. In particular, the clothing may be a shirt or a polo shirt, preferably a shirt. The textile may be a home textile. As illustrative, non-limiting examples, the home textile may be selected from the group consisting of a curtain, a rug, a blanket, a bedsheet, a duvet, a duvet cover, a cushion, a cushion cover and a towel.

The present invention also relates to a method of preparing a fiber according to the invention, comprising:
spinning a melt comprising an aliphatic polyester, an aliphatic-aromatic polyester, and a polyhydroxyalkanoate through a spinning nozzle to obtain a precursor fiber; and
cooling the precursor fiber, thereby obtaining the fiber. The fiber may be further defined as described herein for any fiber.

The term “precursor fiber”, as used herein, in general refers to a fiber that occurs as intermediate during the manufacturing process of the present invention after leaving the spinning nozzle and during the cooling. The (final) fiber of the present invention that is obtainable or being obtained by the method, in particular after the cooling, is in general referred to as just a “fiber”.

A melt for spinning the fiber can be produced using any method for producing a melt for spinning a fiber which is known to a person skilled in the art. As an illustrative example, the aliphatic polyester, aliphatic-aromatic polyester and polyhydroxyalkanoate can be mixed in the unmolten state, e.g. by mixing granules of the polymers, optionally with addition of one or more further additives. Optionally, the polymers and, if present, the additive(s) may be dried before the mixing and the preparation of the melt. Then, for preparing the melt, the mixture can be heated to or above the melting point(s) of the polymers. As an illustrative example, the mixing and heating may be carried out in an extruder. In some embodiments, the melt may have a temperature, in particular before spinning through a spinning nozzle, in a range of from 200° C. to 260°, preferably of from 220° C. to 250° C., more preferably of from 230° C. to 250° C., still more preferably of from 230° C. to 240° C. As an illustrative example, the melt may be heated to a temperature of 235° C. The melt is then passed through a spinning nozzle. As an illustrative example, an extruder may be used for passing the melt through the hollow fiber spinning nozzle. Any spinning nozzle generally known in the art may be used. By spinning a melt comprising an aliphatic polyester, an aliphatic aromatic polyester, and a polyhydroxyalkanoate through a spinning nozzle, a hot precursor fiber is obtained. The hot precursor fiber, which is obtained by spinning the melt through the spinning nozzle, is cooled, thereby obtaining the fiber.

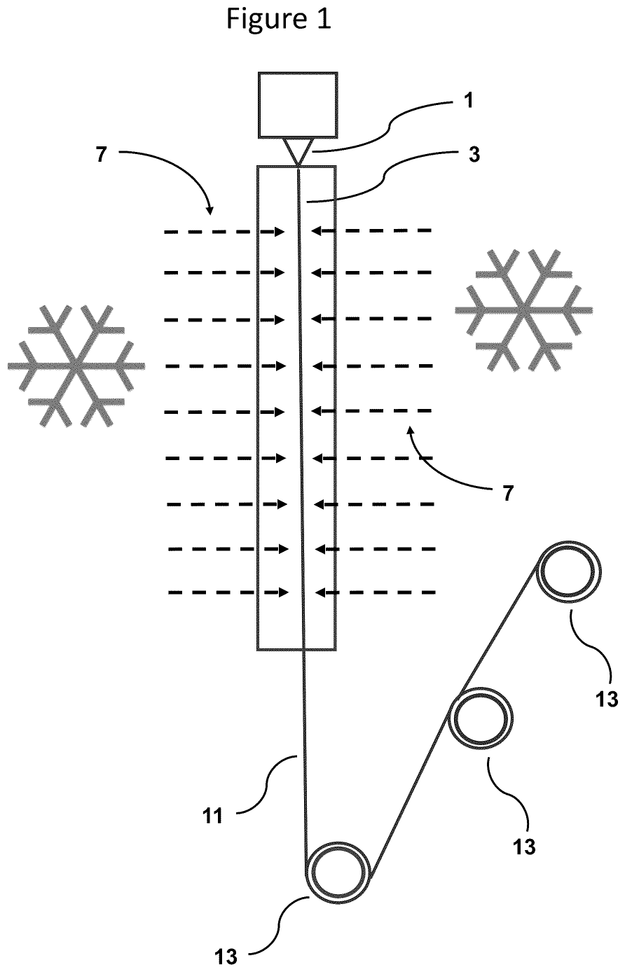

Cooling of the precursor fiber can be effected by using any suitable means/devices for cooling. Suitable means/devices for cooling can be readily selected by a person skilled in the art. For example, one or more temperature control elements may be used for cooling. As illustrative examples, temperature control elements can be arranged and/or operated within the spinning apparatus or the vicinity of the spinning apparatus. Apparatuses for melt spinning are generally known to a person skilled in the art. The temperature control elements can be heating and/or cooling elements which can either actively or passively provide a heating or cooling effect to the precursor fiber. An illustrative, but non-limiting example for a temperature control element, which is a cooling element, is an air cooling aggregate, which can provide an air flow onto the precursor fiber. For example, air cooling aggregates can be arranged on the sides of the precursor fiber, which may provide an air flow in a substantially vertical direction relative to a longitudinal direction of the precursor fiber; see, e.g., FIG. 1, precursor fiber 3 and air flows 7. By arranging cooling aggregates on both sides of the precursor fiber, cooling of the precursor fiber can be effected under a substantially homogeneous temperature distribution through the fiber. The air used for the air cooling may have ambient temperature, preferably room temperature, more preferably a temperature of +20° C.+/−5° C. However, while air cooling using cooling aggregates is shown in FIG. 1, it also possible to effect air cooling by simply exposing the precursor fiber to ambient air, i.e. without providing an air flow onto the precursor fiber from cooling aggregates. It is also possible to use any other suitable cooling means, such as e.g. water cooling.

In some embodiments, the cooling is effected by air cooling.

Preferably, the melt comprises the aliphatic polyester in an amount of from 30 to 70% by weight, based on 100% by weight of the combined amount of the aliphatic polyester, the aliphatic-aromatic polyester, and the polyhydroxyalkanoate. More preferably, the melt comprises the aliphatic polyester in an amount of from 35 to 65% by weight, based on 100% by weight of the combined amount of the aliphatic polyester, the aliphatic-aromatic polyester, and the polyhydroxyalkanoate. Still more preferably, the melt comprises the aliphatic polyester in an amount of from 40 to 60% by weight or 42 to 62% by weight, based on 100% by weight of the combined amount of the aliphatic polyester, the aliphatic-aromatic polyester, and the polyhydroxyalkanoate. Even more preferably, the melt comprises the aliphatic polyester in an amount of from 45 to 55% by weight, based on 100% by weight of the combined amount of the aliphatic polyester, the aliphatic-aromatic polyester, and the polyhydroxyalkanoate. In particular, these ranges can be applied when the aliphatic polyester is a polybutylene succinate. In a preferred embodiment, the melt comprises 52% by weight of a polybutylene succinate based on 100% by weight of the combined amount of the polybutylene succinate, an aliphatic aromatic polyester and a polyhydroxyalkanoate.

Preferably, the melt comprises the aliphatic-aromatic polyester in an amount of from 10 to 60% by weight, based on 100% by weight of the combined amount of the aliphatic polyester, the aliphatic-aromatic polyester, and the polyhydroxyalkanoate. More preferably, the melt comprises the aliphatic-aromatic polyester in an amount of from 20 to 50% by weight, based on 100% by weight of the combined amount of the aliphatic polyester, the aliphatic-aromatic polyester, and the polyhydroxyalkanoate. Still more preferably, the melt comprises the aliphatic-aromatic polyester in an amount of from 25 to 40% by weight or 26 to 46% by weight, based on 100% by weight of the combined amount of the aliphatic polyester, the aliphatic-aromatic polyester, and the polyhydroxyalkanoate. Even more preferably, the melt comprises the aliphatic-aromatic polyester in an amount of from 30 to 40% by weight, based on 100% by weight of the combined amount of the aliphatic polyester, the aliphatic-aromatic polyester, and the polyhydroxyalkanoate. In particular, these ranges can be applied when the aliphatic-aromatic polyester is a polybutylene adipate terephthalate (PBAT). In a preferred embodiment, the melt comprises 36% by weight polybutylene adipate terephthalate (PBAT) based on 100% by weight of the combined amount of an aliphatic polyester, the polybutylene adipate terephthalate (PBAT) and a polyhydroxyalkanoate.

Preferably, the melt comprises the polyhydroxyalkanoate in an amount of from 1 to 25% by weight, based on 100% by weight of the combined amount of the aliphatic polyester, the aliphatic-aromatic polyester, and the polyhydroxyalkanoate. More preferably, the melt comprises the polyhydroxyalkanoate in an amount of from 2 to 22% by weight, based on 100% by weight of the combined amount of the aliphatic polyester, the aliphatic-aromatic polyester, and the polyhydroxyalkanoate. Still more preferably, the melt comprises the polyhydroxyalkanoate in an amount of 3 to 20 by weight, based on 100% by weight of the combined amount of the aliphatic polyester, the aliphatic-aromatic polyester, and the polyhydroxyalkanoate. Still more preferably, the melt comprises the polyhydroxyalkanoate in an amount of from 3 to 18% by weight, based on 100% by weight of the combined amount of the aliphatic polyester, the aliphatic-aromatic polyester, and the polyhydroxyalkanoate. Even more preferably, the melt comprises the polyhydroxyalkanoate in an amount of from 5 to 15% by weight, based on 100% by weight of the combined amount of the aliphatic polyester, the aliphatic-aromatic polyester, and the polyhydroxyalkanoate. In particular, these ranges can be applied when the polyhydroxyalkanoate is a polyhydroxybutyrate-co-hydroxyhexanoate, preferably a poly(3-hydroxybutyrate-co-3-hydroxyhexanoate) (PHBH). Preferably, when the polyhydroxyalkanoate is a polyhydroxybutyrate-co-hydroxyhexanoate, preferably a poly(3-hydroxybutyrate-co-3-hydroxyhexanoate) (PHBH), the melt comprises 20% by weight or less, more preferably 18% by weight or less of the polyhydroxybutyrate-co-hydroxyhexanoate, preferably a poly(3-hydroxybutyrate-co-3-hydroxyhexanoate) (PHBH) based on 100% by weight of the combined amount of an aliphatic polyester, an aliphatic-aromatic polyester and the polyhydroxybutyrate-co-hydroxyhexanoate, preferably the poly(3-hydroxybutyrate-co-3-hydroxyhexanoate) (PHBH).

The ranges for the amounts of the aliphatic polyester, the aliphatic-aromatic polyester and the polyhydroxyalkanoate may be also combined with each other. Accordingly, as illustrative examples, the melt may comprise the aliphatic polyester in an amount of from 42 to 62% by weight, preferably 45 to 55% by weight, the melt may comprise the aliphatic-aromatic polyester in an amount of from 26 to 46% by weight, preferably 30 to 40% by weight, and the melt may comprise the polyhydroxybutyrate in an amount of from 2 to 22% by weight, preferably 3 to 20% by weight, more preferably 3 to 18% by weight, each based on 100% by weight of the combined amount of the aliphatic polyester, the aliphatic-aromatic polyester and the polyhydroxyalkanoate. A person skilled in the art will readily select suitable amounts of one or more of the polymer(s) within the ranges provided herein, so that the total amount of 100% by weight of the combined amount of the aliphatic polyester, the aliphatic-aromatic polyester and the polyhydroxyalkanoate is not exceeded. In particular, these ranges can be applied when the aliphatic polyester is a polybutylene succinate, the aliphatic aromatic polyester is a polybutylene adipate terephthalate, and the polyhydroxyalkanoate is a polyhydroxybutyrate-co-hydroxyhexanoate, preferably a poly(3-hydroxybutyrate-co-3-hydroxyhexanoate) (PHBH). In a very preferred embodiment, the melt comprises 52% by weight of a polybutylene succinate, 36% by weight of a polybutylene adipate terephthalate and 12% by weight of a polyhydroxybutyrate-co-hydroxyhexanoate, preferably a poly(3-hydroxybutyrate-co-3-hydroxyhexanoate) (PHBH), each based on 100% by weight of the combined amount of the polybutylene succinate, the polybutylene adipate terephthalate and the polyhydroxybutyrate-co-hydroxyhexanoate, preferably the poly(3-hydroxybutyrate-co-3-hydroxyhexanoate) (PHBH).

In some embodiments, the polyhydroxyalkanoate may be partially or totally replaced by a polylactide (PLA, or also known as polylactic acid or poly(lactic acid)). Accordingly, in some embodiments, when the polyhydroxyalkanoate is partially replaced by a polylactide, the melt comprises the aliphatic polyester, the aliphatic-aromatic polyester, the polyhydroxyalkanoate, and a polylactide. In some embodiments, when the polyhydroxyalkanoate is totally replaced by a polylactide, the melt comprises the aliphatic polyester, the aliphatic-aromatic polyester, and the polylactide. However, in embodiments where the polyhydroxyalkanoate is totally replaced by a polylactide, the melt does not contain a polyhydroxyalkanoate.

Optionally, the melt may further comprise at least one additive. For example, the melt may comprise at least one additive as generally known to be used in a textile fiber. The optional additives may include, but are not limited to, an additive selected from the group consisting of a flame retardant, a matting agent, a marker for authentication (e.g., a fluorescence marker), an antimicrobial agent, a plasticizer, a colorant, a filler, and any combination thereof.

Preferably, the melt further comprises a flame retardant. More preferably, the flame retardant is a phosphate. In preferred embodiments, the flame retardant is selected from the group consisting of ammonium dihydrogenphosphate ([NH₄][H₂PO₄]), di-ammonium hydrogenphosphate ([NH₄]₂[HPO₄]), triammonium phosphate ([NH₄]₃[PO₄]) and any combination thereof. More preferably, the flame retardant is selected from the group consisting of ammonium dihydrogenphosphate ([NH₄][H₂PO₄]), di-ammonium hydrogenphosphate ([NH₄]₂[HPO₄]) and any combination thereof. More preferably, the flame retardant is ammonium dihydrogenphosphate ([NH₄][H₂PO₄]) or di-ammonium hydrogenphosphate ([NH₄]₂[HPO₄]). Still more preferably, the flame retardant is di-ammonium hydrogenphosphate ([NH₄]₂[HPO₄]). Alternatively, or in addition, the flame retardant may be a polyphosphate. Preferably, when the flame retardant is a polyphosphate, the flame retardant is ammonium polyphosphate.

The melt may comprise the flame retardant in an amount of from 0.01 to 5% by weight, based on 100% by weight of the total weight of the melt. Preferably, the melt comprises the flame retardant in an amount of from 0.1 to 4% by weight, based on 100% by weight of the total weight of the melt. More preferably, the melt comprises the flame retardant in an amount of from 0.2% to 3% by weight, based on 100% by weight of the total weight of the melt. Still more preferably, the melt comprises the flame retardant in an amount of from 0.3 to 3% by weight, based on 100% by weight of the total weight of the melt. Even more preferably, the melt comprises the flame retardant in an amount of from 0.3 to 2% by weight, based on 100% by weight of the total weight of the melt. In particular, the foregoing ranges can be applied when the flame retardant is a phosphate or a polyphosphate, preferably, when the flame retardant is di-ammonium hydrogenphosphate ([NH₄]₂[HPO₄]).

A person skilled in the art will readily select suitable amount(s) of the additive(s) to be comprised in the melt. As an illustrative example, the melt may comprise a total amount of additive(s) of 15% by weight or less, based on 100% by weight of the total weight of the melt. The melt may comprise a total amount of additive(s) of 10% by weight or less, based on 100% by weight of the total weight of the melt. Preferably, the melt comprises a total amount of additives of 7% by weight or less, based on 100% by weight of the total weight of the melt. More preferably, the melt comprises a total amount of additives of 5% by weight or less, based on 100% by weight of the total weight of the melt. Still more preferably, the melt comprises a total amount of additives of 4% by weight or less, based on 100% by weight of the total weight of the melt. Even more preferably, the melt comprises a total amount of additives of 3 to 4% by weight, based on 100% by weight of the total weight of the melt. It is preferred that the melt comprises a total amount of additives of 7% by weight or less, more preferably 3 to 4% by weight, each based on 100% by weight of the total weight of the melt, in order to achieve a stiffness of the fiber which is useful for a textile fiber.

The fiber may be prepared as a staple fiber.

The fiber may be prepared as a filament.

In some embodiments, the spinning nozzle is not a hollow fiber spinning nozzle. The term “hollow fiber spinning nozzle”, as used herein, refers to any hollow fiber spinning nozzle generally known in the art. A merely illustrative example for a hollow fiber spinning nozzle is described, e.g., in EP 2 112 256, the whole content of which is hereby incorporated by reference.

In some embodiments, the method is not a method of preparing a fiber as described in international patent application PCT/EP2022/075084. In particular, in some embodiments, the method is not:
a method of preparing a fiber, comprising:
   spinning a melt comprising an aliphatic polyester, an aliphatic-aromatic polyester, and a polyhydroxyalkanoate through a hollow fiber spinning nozzle to obtain a precursor fiber; and
   cooling the precursor fiber under a temperature gradient, thereby obtaining the fiber.

The present invention also relates to a fiber obtainable or being obtained by a method of preparing a fiber according to the invention.

The present invention also relates to a use of a melt comprising an aliphatic polyester, an aliphatic-aromatic polyester, and a polyhydroxyalkanoate for the preparation of a fiber, wherein the fiber is as defined herein.

The present invention also relates to a use of a melt comprising an aliphatic polyester, an aliphatic-aromatic polyester, and a polyhydroxyalkanoate for the preparation of a fiber.

### Filament Suitable for Three-Dimensional Printinq

The present invention also relates to a filament suitable for three-dimensional printing being made from a mixture comprising an aliphatic polyester, an aliphatic-aromatic polyester, and a polyhydroxyalkanoate.

It has been found that a mixture comprising an aliphatic polyester, an aliphatic-aromatic polyester and a polyhydroxyalkanoate is well suited for preparing a filament, which filament can be used for three-dimensional printing. In particular, a filament comprising an aliphatic polyester, an aliphatic-aromatic polyester and a polyhydroxyalkanoate can be obtainable or can be obtained by extruding a melt comprising an aliphatic polyester, an aliphatic aromatic polyester and a polyhydroxyalkanoate into the shape of a filament. In this regard, it has been found that a mixture comprising an aliphatic polyester, an aliphatic-aromatic polyester and a polyhydroxyalkanoate exhibits a good extrudability, in particular good properties for extrusion into a filament. As yet a further advantage, as shown with regard to the fiber of the invention (see Example 2), the production of the filament suitable for three-dimensional printing can be carried out without toxic substances, such as e.g. antimony. Further, by using an aliphatic polyester, an aliphatic-aromatic polyester, and a polyhydroxyalkanoate, a filament suitable for three-dimensional printing can be obtained which is biodegradable and even meets the harmonized European standard EN 13432 and can thus be treated in industrial composting plants. It has also turned out that a filament of the invention comprising an aliphatic polyester, an aliphatic-aromatic polyester and a polyhydroxyalkanoate is well suited for the preparation of a three-dimensionally printed article by using a conventional three-dimensional printer (3D printer), such as e.g. a three-dimensional printer operating under the material extrusion technique. Accordingly, a three-dimensionally printed article, which is also biodegradable and can even meet the harmonized European standard EN 13432, can be prepared from the filament suitable for three-dimensional printing according to the invention. In this context it is noted that various products, such as e.g. plates and foils, but also fibers, which comprise one or more of an aliphatic polyester, aliphatic-aromatic polyester, and/or a polyhydroxyalkanoate are described, e.g., in EP 3 626 767, WO 2010/034689, WO 2010/034711, WO 2015/169660, EP 1 966 419, EP 2 984 138, CN 103668540, CN 103668541, WO 2014/173055 and CN 104120502.

The term three-dimensional printing, also known as “3D printing” or “additive manufacturing”, as used in the art, in general refers to the construction of a three-dimensional object, e.g. from a CAD model or a digital 3D model. It can be done in a variety of processes in which material is deposited, joined or solidified under computer control, with material being added together (such as plastics, liquids or powder grains being fused), typically layer by layer. At present, three-dimensional printers (hereinafter sometimes referred to as “3D printers”) of various additive manufacturing technologies (e.g., the binder jetting technique, material extrusion technique, and vat photopolymerization technique) are on the market. Of these, 3D printer systems based on the material extrusion technique (e.g., the system manufactured by Stratasys Inc., U.S.A.) are used for building a three-dimensional object layer-by-layer by extruding a flowable raw material from a nozzle part provided to an extrusion head, on the basis of a computer-aided design (CAD) model. This system is an illustrative example for a simple system in which a filament comprising raw material constituted of a thermoplastic resin is inserted into the extrusion head and continuously extruded, with being heated and melted, from the nozzle part provided to the extrusion head onto the X-Y plane platen within the chamber, and the extruded resin is deposited on and also fused to a resin deposit which has already been formed, and is integrated therewith by solidification as the extruded resin becomes cool. In the material extrusion method, the extrusion step is usually repeated while the nozzle position relative to the platen rises in the Z-axis direction, which is perpendicular to the X-Y plane, thereby building a three-dimensional object akin to a CAD model. The filament suitable for three-dimensional printing according to the invention can be used for preparing a three-dimensionally printed article applying, for example, the material extrusion technique.

The filament suitable for three-dimensional printing of the invention may be further defined as described herein for any fiber of the invention.

The term “aliphatic polyester” as used herein in general refers to a polyester which is typically synthesized through a condensation polymerization of an aliphatic diol and an aliphatic dicarboxylic acid or an anhydride thereof. As an illustrative example, the aliphatic polyester as used herein may comprise an aliphatic C₂-C₂₀ dicarboxylic acid and an aliphatic C₂-C₁₂ diol. Preferably, the aliphatic diol is an aliphatic C₂-C₈ diol. More preferably, the aliphatic diol is an aliphatic C₂-C₆ diol. Even more preferably, the aliphatic diol is an aliphatic C₃ diol or an aliphatic C₄ diol. Aliphatic diols used in the aliphatic polyester may include, as illustrative examples, ethylene glycol, propylene glycol, 1,3-propanediol, 1,3-butanediol, 1,4-butanediol, 1,5 pentanediol, and 1,6-hexanediol. Preferably, the aliphatic diol is 1,3-propanediol or 1,4-butanediol. More preferably, the aliphatic diol is 1,4-butanediol. Preferably, the aliphatic dicarboxylic acid is an aliphatic C₂-C₁₂ dicarboxylic acid. More preferably, the aliphatic dicarboxylic acid is an aliphatic C₂-C₈ dicarboxylic acid, even more preferably an aliphatic C₄ dicarboxylic acid. Aliphatic dicarboxylic acids used in the aliphatic polyester may include, as illustrative examples, oxalic acid, malonic acid, succinic acid, glutaric acid, and adipic acid. Preferably, the aliphatic dicarboxylic acid is malonic acid or succinic acid. More preferably, the aliphatic dicarboxylic acid is succinic acid. Optionally, when the dicarboxylic acid is an aliphatic C₂-C₁₂ dicarboxylic acid, the aliphatic polyester may further comprise an additional aliphatic C₆-C₂₀ dicarboxylic acid, which is different from the C₂-C₁₂ dicarboxylic acid. The optional aliphatic C₆-C₁₂ dicarboxylic acids may include, as illustrative examples, adipic acid, suberic acid, azelaic acid, sebacic acid, brassylic acid and arachidonic acid. Preferably, the optional aliphatic C₆-C₁₂ dicarboxylic acids may include adipic acid, suberic acid, azelaic acid, sebacic acid and brassylic acid. The optional aliphatic C₂-C₁₂ dicarboxylic acid may be present in the aliphatic polyester at a ratio of from 0 to 10 mol-%, based on 100 mol-% of the total amount of aliphatic dicarboxylic acids in the aliphatic polyester. Optionally, the aliphatic polyester may further comprise a chain extender and/or a branching agent. Optional chain extenders and/or branching agents may include, as illustrative examples, a polyfunctional isocyanate, isocyanurate, oxazoline, carboxylic anhydride such as e.g. maleic anhydride, epoxide (in particular an epoxy-containing poly(meth)acrylate), an at least trihydric alcohol, and an at least tribasic carboxylic acid. The optional chain extender and/or branching agent may be present in the aliphatic polyester at a ratio of from 0 to 1% by weight based on 100% by weight of the combined amount of aliphatic dicarboxylic acid(s) and aliphatic diol. The term “aliphatic polyester” may also include a mixture of two or more different aliphatic polyesters. The aliphatic polyester may have a number average molecular weight (Mn) ranging from 2,500 to 150,000 g/mol, preferably from 5,000 to 100,000 g/mol, more preferably from 7,500 to 75,000 g/mol, still more preferably from 10,000 to 65,000 g/mol, even more preferably from 12,000 to 60,000 g/mol. The aliphatic polyester may have a weight average molecular weight (Mw) ranging from 5,000 to 300,000 g/mol, preferably from 10,000 to 250,000 g/mol, more preferably from 20,000 to 220,000 g/mol, still more preferably from 50,000 to 200,000 g/mol, even more preferably from 60,000 to 190,000 g/mol. The aliphatic polyester may have a polydispersity index (i.e. the ratio of the weight average molecular weight to the number average molecular weight (Mw/Mn)) ranging from 1 to 6, preferably from 1 to 4, more preferably from 1.0 to 3.0, still more preferably from 1.2 to 2.0, even more preferably from 1.4 to 1.8.

Illustrative examples of aliphatic polyesters, which can be used in the present invention, may include an aliphatic polyester selected from the group consisting of a polybutylene succinate (PBS), a polyethylene oxalate, a polyethylene malonate, a polyethylene succinate, a polypropylene oxalate, a polypropylene malonate, a polypropylene succinate, a polybutylene oxalate, a polybutylene malonate, a polybutylene succinate-co-adipate (PBSA), a polybutylene succinate-co-azelate (PBSAz), a polybutylene succinate-co-brassylate (PBSBr), and any combination thereof. The aliphatic polyester may preferably be selected from the group consisting of a polybutylene succinate (PBS), a polybutylene succinate-co-adipate (PBSA), a polybutylene succinate-co-azelate (PBSAz), a polybutylene succinate-co-brassylate (PBSBr), and any combination thereof. In one preferred embodiment, the aliphatic polyester is a polybutylene succinate. The term “polybutylene succinate” as used herein in particular denotes a condensation product from the aliphatic dicarboxylic acid succinic acid and the aliphatic diol 1,4-butanediol. The aliphatic polyesters polybutylene succinate (PBS) and polybutylene succinate-co-adipate (PBSA) are commercially available, for example, from Showa Highpolymer as Blanche®, and by Mitsubishi as GSPIa®. The aliphatic polyester, in particular polybutylene succinate (PBS), may be obtained from renewable resources or from fossil resources. Preferably, an aliphatic polyester from renewable resources is used. More preferably, bio-based polybutylene succinate (PBS) produced from bio-based succinic acid and 1,4-butanediol, which is e.g. commercially available from Mitsubishi Chemicals under the tradename BioPBS™ FZ71, can be used. Preferably, the aliphatic polyester is biodegradable. In particular, polybutylene succinate (PBS) is a biodegradable aliphatic polyester.

Preferably, the filament suitable for three-dimensional printing comprises the aliphatic polyester in an amount of from 30 to 70% by weight, based on 100% by weight of the combined amount of the aliphatic polyester, the aliphatic-aromatic polyester, and the polyhydroxyalkanoate. More preferably, the filament comprises the aliphatic polyester in an amount of from 35 to 65% by weight, based on 100% by weight of the combined amount of the aliphatic polyester, the aliphatic-aromatic polyester, and the polyhydroxyalkanoate. Still more preferably, the filament comprises the aliphatic polyester in an amount of from 40 to 60% by weight or 42 to 62% by weight, based on 100% by weight of the combined amount of the aliphatic polyester, the aliphatic-aromatic polyester, and the polyhydroxyalkanoate. Even more preferably, the filament comprises the aliphatic polyester in an amount of from 45 to 55% by weight, based on 100% by weight of the combined amount of the aliphatic polyester, the aliphatic-aromatic polyester, and the polyhydroxyalkanoate. In particular, these ranges can be applied when the aliphatic polyester is a polybutylene succinate. In a preferred embodiment, the filament comprises 52% by weight of a polybutylene succinate based on 100% by weight of the combined amount of the polybutylene succinate, an aliphatic aromatic polyester and a polyhydroxyalkanoate.

The term “aliphatic-aromatic polyester” as used herein in general refers to a polyester which is typically synthesized from an aliphatic diol, an aliphatic dicarboxylic acid and an aromatic dicarboxylic acid. As an illustrative example, the aliphatic-aromatic polyester may comprise an aliphatic C₂-C₂₀ dicarboxylic acid, an aromatic dicarboxylic acid and an aliphatic C₂-C₁₂ diol. Preferably, the aliphatic diol is an aliphatic C₂-C₈ diol. More preferably, the aliphatic diol is an aliphatic C₂-C₆ diol. Even more preferably, the aliphatic diol is an aliphatic C₃ diol or an aliphatic C₄ diol. Aliphatic diols used in the aliphatic-aromatic polyester may include, as illustrative examples, ethylene glycol, propylene glycol, 1,3-propanediol, 1,3-butanediol, 1,4-butanediol, 1,5 pentanediol, and 1,6-hexanediol. Preferably, the aliphatic diol is 1,3-propanediol or 1,4-butanediol. More preferably, the aliphatic diol is 1,4-butanediol. Preferably, the aliphatic dicarboxylic acid is an aliphatic C₂-C₁₂ dicarboxylic acid. More preferably, the aliphatic dicarboxylic acid is an aliphatic C₄-C₁₀ dicarboxylic acid, even more preferably an aliphatic C₆ dicarboxylic acid. Aliphatic dicarboxylic acids used in the aliphatic-aromatic polyester may include, as illustrative examples, glutaric acid, adipic acid, pimelic acid, azelaic acid, sebacic acid, brassylic acid, suberic acid, and itaconic acid. Preferably, the aliphatic dicarboxylic acid is adipic acid, azelaic acid, or sebacic acid. More preferably, the aliphatic dicarboxylic acid is adipic acid. Preferably, the aromatic dicarboxylic acid is terephthalic acid. The aromatic dicarboxylic acid, in particular terephthalic acid, may be present in the aliphatic-aromatic polyester in an amount of e.g. from 30 to 70 mol-%, preferably of from 40 to 60 mol-%, more preferably of from 40 to 55 mol-%, each based on 100 mol-% of the combined amount of the aliphatic dicarboxylic acid and the aromatic dicarboxylic acid. Optionally, the aliphatic polyester may further comprise a chain extender and/or a branching agent. Optional chain extenders may include, as illustrative examples, a di- or polyfunctional isocyanate, preferably hexamethylenediisocyanate. Optional branching agents may include, as illustrative examples, trimethylolpropane, pentaerythritol, and preferably glycerol. The optional chain extender and/or branching agent may be present in the aliphatic polyester at a ratio of from 0 to 1% by weight based on 100% by weight of the combined amount of the aliphatic dicarboxylic acid, the aromatic dicarboxylic acid, and the aliphatic diol. The term “aliphatic-aromatic polyester” may also include a mixture of two or more different aliphatic-aromatic polyesters. The aliphatic-aromatic polyester may have a number average molecular weight (Mn) ranging from 1,000 to 500,000 g/mol, preferably from 5,000 to 300,000 g/mol, more preferably from 5,000 to 100,000 g/mol, still more preferably from 10,000 to 75,000 g/mol, even more preferably from 15,000 to 50,000 g/mol. The aliphatic-aromatic polyester may have a weight average molecular weight (Mw) ranging from 10,000 to 500,000 g/mol, preferably from 20,000 to 400,000 g/mol, more preferably from 30,000 to 300,000 g/mol, still more preferably from 60,000 to 200,000 g/mol. The aliphatic-aromatic polyester may have a polydispersity index (i.e. the ratio of the weight average molecular weight to the number average molecular weight (Mw/Mn)) ranging from 1 to 6, preferably from 2 to 4, more preferably from 1.0 to 3.0, still more preferably from 1.2 to 2.0, even more preferably from 1.4 to 1.8.

Aliphatic-aromatic polyesters, which can be used in the present invention, may include, but are not limited to, an aliphatic-aromatic polyester selected from the group consisting of a polybutylene adipate terephthalate (PBAT), a polybutylene succinate terephthalate (PBST), a polybutylene sebacate terephthalate (PBSeT), and any combination thereof. In one preferred embodiment, the aliphatic-aromatic polyester is a polybutylene adipate terephthalate (PBAT). The term “polybutylene adipate terephthalate” as used herein denotes an aliphatic-aromatic polyester which comprises the aliphatic dicarboxylic acid adipic acid, the aromatic dicarboxylic acid terephthalic acid, and the aliphatic diol 1,4-butanediol. The aliphatic-aromatic polyester, in particular polybutylene adipate terephthalate (PBAT), may be obtained from renewable resources or from fossil resources. Preferably, an aliphatic-aromatic polyester from renewable resources is used. Polybutylene adipate terephthalate (PBAT) is marketed, for example, by BASF as Ecoflex®, e.g. Ecoflex® F Blend C1200 or Ecoflex® FBX 7011, or by Showa Denko as Bionolle®. Preferably, the aliphatic-aromatic polyester is biodegradable. In particular, polybutylene adipate terephthalate (PBAT) is a biodegradable aliphatic-aromatic polyester.

Preferably, the filament suitable for three-dimensional printing comprises the aliphatic-aromatic polyester in an amount of from 10 to 60% by weight, based on 100% by weight of the combined amount of the aliphatic polyester, the aliphatic-aromatic polyester, and the polyhydroxyalkanoate. More preferably, the filament comprises the aliphatic-aromatic polyester in an amount of from 20 to 50% by weight, based on 100% by weight of the combined amount of the aliphatic polyester, the aliphatic-aromatic polyester, and the polyhydroxyalkanoate. Still more preferably, the filament comprises the aliphatic-aromatic polyester in an amount of from 25 to 40% by weight or 26 to 46% by weight, based on 100% by weight of the combined amount of the aliphatic polyester, the aliphatic-aromatic polyester, and the polyhydroxyalkanoate. Even more preferably, the filament comprises the aliphatic-aromatic polyester in an amount of from 30 to 40% by weight, based on 100% by weight of the combined amount of the aliphatic polyester, the aliphatic-aromatic polyester, and the polyhydroxyalkanoate. In particular, these ranges can be applied when the aliphatic-aromatic polyester is a polybutylene adipate terephthalate (PBAT). In a preferred embodiment, the filament comprises 36% by weight polybutylene adipate terephthalate (PBAT) based on 100% by weight of the combined amount of an aliphatic polyester, the polybutylene adipate terephthalate (PBAT) and a polyhydroxyalkanoate.

The term “polyhydroxyalkanoate” as used herein in general refers to a polyester from hydroxyalkane carboxylic acid monomers. Polyhydroxyalkanoates can be produced by numerous microorganisms, including through bacterial fermentation of sugars or lipids. Preferably, the hydroxyalkane carboxylic acid is a C₄-C₁₈ hydroxyalkane carboxylic acid, i.e. preferably the hydroxyalkane carboxylic acid comprises 4 to 18 carbon atoms. More preferably, the polyhydroxyalkanoate comprises monomeric units having the following formula (I):

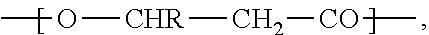

wherein R is an alkyl group having the formula CₙH₂ₙ₊₁, and n is an integer of from 1 to 15, preferably of from 1 to 6. In some embodiments, the polyhydroxyalkanoate is a homopolymer. In some preferred embodiments, the polyhydroxyalkanoate is a copolymer. When the polyhydroxyalkanoate is a copolymer, the copolymer may comprise two different monomeric units of formula (I). The term “polyhydroxyalkanoate” may also include a mixture of two or more different polyhydroxyalkanoates. The polyhydroxyalkanoate may have a weight average molecular weight (Mw) ranging from 70,000 to 1,000,000 g/mol, preferably from 100,000 to 1,000,000 g/mol, more preferably from 300,000 to 600,000 g/mol.

Illustrative examples of polyhydroxyalkanoates, which can be used in the present disclosure, may include a polyhydroxyalkanoate selected from the group consisting of a polyhydroxybutyrate, a polyhydroxyvalerate, a polyhydroxybutyrate-co-hydroxyvalerate, a polyhydroxybutyrate-co-hydroxyhexanoate, and any combination thereof. Preferably, the polyhydroxyalkanoate is selected from the group consisting of a poly-3-hydroxybutyrate (P3HB), a poly-4-hydroxybutyrate (P4HB), a poly-3-hydroxyvalerate (PHV), a poly(3-hydroxybutyrate-co-4-hydroxybutyrate), a poly(3-hydroxybutyrate-co-3-hydroxyvalerate) (PHBV), a poly(3-hydroxybutyrate-co-3-hydroxyhexanoate) (PHBH), and any combination thereof. Still more preferably, the polyhydroxyalkanoate is selected from the group consisting of a poly-3-hydroxybutyrate (PHB)

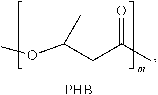

a poly(3-hydroxybutyrate-co-3-hydroxyvalerate) (PHBV)

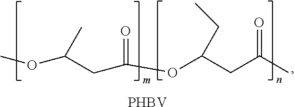

and
a poly(3-hydroxybutyrate-co-3-hydroxyhexanoate) (PHBH)

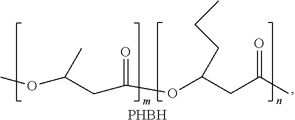

and
any combination thereof. Even more preferably, the polyhydroxyalkanoate is a polyhydroxybutyrate-co-hydroxyhexanoate. In a very preferred embodiment, the polyalkoxyalkanoate is a poly(3-hydroxybutyrate-co-3-hydroxyhexanoate) (PHBH). Preferably, the molar ratio m:n in the foregoing structural formulae is of from 95:5 to 85:15, more preferably of from 90:10 to 88:12. Preferably, a poly(3-hydroxybutyrate-co-3-hydroxyhexanoate) (PHBH) having a molar ratio of 3-hydroxyhexanoate of from 5 to 15 mol-%, preferably of from 7 to 13 mol-%, more preferably of from 10 to 13 mol-%, each based on 100 mol-% of the total amount of monomers in the poly(3-hydroxybutyrate-co-3-hydroxyhexanoate) (PHBH), is used. Poly(3-hydroxybutyrate-co-3-hydroxyhexanoate) (PHBH) is marketed by way of example by P&G or Kaneka. The polyhydroxyalkanoate, in particular poly(3-hydroxybutyrate-co-3-hydroxyhexanoate) (PHBH), may be obtained from renewable resources or fossil resources. Preferably, a polyhydroxyalkanoate from renewable resources is used. More preferably, bio-based poly(3-hydroxybutyrate-co-3-hydroxyhexanoate) (PHBH), which is e.g. commercially available from Kaneka under the tradename AONILEX X 151 A, can be used. Preferably, the polyhydroxyalkanoate is biodegradable. In particular, poly(3-hydroxybutyrate-co-3-hydroxyhexanoate) (PHBH) is a biodegradable polyhydroxyalkanoate.

Preferably, the filament suitable for three-dimensional printing comprises the polyhydroxyalkanoate in an amount of from 1 to 25% by weight, based on 100% by weight of the combined amount of the aliphatic polyester, the aliphatic-aromatic polyester, and the polyhydroxyalkanoate. More preferably, the filament comprises the polyhydroxyalkanoate in an amount of from 2 to 22% by weight, based on 100% by weight of the combined amount of the aliphatic polyester, the aliphatic-aromatic polyester, and the polyhydroxyalkanoate. Still more preferably, the filament comprises the polyhydroxyalkanoate in an amount of 3 to 20 by weight, based on 100% by weight of the combined amount of the aliphatic polyester, the aliphatic-aromatic polyester, and the polyhydroxyalkanoate. Still more preferably, the filament comprises the polyhydroxyalkanoate in an amount of from 3 to 18% by weight, based on 100% by weight of the combined amount of the aliphatic polyester, the aliphatic-aromatic polyester, and the polyhydroxyalkanoate. Even more preferably, the filament comprises the polyhydroxyalkanoate in an amount of from 5 to 15% by weight, based on 100% by weight of the combined amount of the aliphatic polyester, the aliphatic-aromatic polyester, and the polyhydroxyalkanoate. In particular, these ranges can be applied when the polyhydroxyalkanoate is a polyhydroxybutyrate-co-hydroxyhexanoate, preferably a poly(3-hydroxybutyrate-co-3-hydroxyhexanoate) (PHBH). Preferably, when the polyhydroxyalkanoate is a polyhydroxybutyrate-co-hydroxyhexanoate, preferably a poly(3-hydroxybutyrate-co-3-hydroxyhexanoate) (PHBH), the filament comprises 20% by weight or less, more preferably 18% by weight or less of the polyhydroxybutyrate-co-hydroxyhexanoate, preferably the poly(3-hydroxybutyrate-co-3-hydroxyhexanoate) (PHBH) based on 100% by weight of the combined amount of an aliphatic polyester, an aliphatic-aromatic polyester and the polyhydroxybutyrate-co-hydroxyhexanoate, preferably the poly(3-hydroxybutyrate-co-3-hydroxyhexanoate) (PHBH). If the ratio of the polyhydroxybutyrate-co-hydroxyhexanoate, preferably the poly(3-hydroxybutyrate-co-3-hydroxyhexanoate) (PHBH) exceeds 18% by weight, achieving the EN 13432 standard for biodegradability without pre-composting or industrial composting may become difficult, when exceeding 20% by weight still more difficult. In a preferred embodiment, the filament comprises 12% by weight poly(3-hydroxybutyrate-co-3-hydroxyhexanoate) (PHBH) based on 100% by weight of the combined amount of a polybutylene succinate, a polybutylene adipate terephthalate and a poly(3-hydroxybutyrate-co-3-hydroxyhexanoate) (PHBH).

In one very preferred embodiment, the aliphatic polyester is a polybutylene succinate (PBS), the aliphatic-aromatic polyester is a polybutylene adipate terephthalate (PBAT), and the polyalkoxyalkanoate is a poly(3-hydroxybutyrate-co-3-hydroxyhexanoate) (PHBH). Accordingly, in one very preferred embodiment, the filament suitable for three-dimensional printing comprises a polybutylene succinate (PBS), a polybutylene adipate terephthalate (PBAT), and a poly(3-hydroxybutyrate-co-3-hydroxyhexanoate) (PHBH).

The ranges for the amounts of the aliphatic polyester, the aliphatic-aromatic polyester and the polyhydroxyalkanoate may be also combined with each other. Accordingly, as illustrative examples, the filament suitable for three-dimensional printing may comprise the aliphatic polyester in an amount of from 42 to 62% by weight, preferably 45 to 55% by weight, the filament may comprise the aliphatic-aromatic polyester in an amount of from 26 to 46% by weight, preferably 30 to 40% by weight, and the filament may comprise the polyhydroxyalkanoate in an amount of from 2 to 22% by weight, preferably 3 to 20% by weight, more preferably 3 to 18% by weight, each based on 100% by weight of the combined amount of the aliphatic polyester, the aliphatic-aromatic polyester and the polyhydroxyalkanoate. A person skilled in the art will readily select suitable amounts of one or more of the polymer(s) within the ranges provided herein, so that the total amount of 100% by weight of the combined amount of the aliphatic polyester, the aliphatic-aromatic polyester and the polyhydroxyalkanoate is not exceeded. In particular, these ranges can be applied when the aliphatic polyester is a polybutylene succinate, the aliphatic aromatic polyester is a polybutylene adipate terephthalate, and the polyhydroxyalkanoate is a polyhydroxybutyrate-co-hydroxyhexanoate, preferably a poly(3-hydroxybutyrate-co-3-hydroxyhexanoate) (PHBH).

In a very preferred embodiment, the filament comprises 52% by weight of a polybutylene succinate, 36% by weight of a polybutylene adipate terephthalate and 12% by weight of a polyhydroxybutyrate-co-hydroxyhexanoate, preferably a poly(3-hydroxybutyrate-co-3-hydroxyhexanoate) (PHBH), each based on 100% by weight of the combined amount of the polybutylene succinate, the polybutylene adipate terephthalate and the polyhydroxybutyrate-co-hydroxyhexanoate, preferably the poly(3-hydroxybutyrate-co-3-hydroxyhexanoate) (PHBH).

In some embodiments, the polyhydroxyalkanoate may be partially or totally replaced by a polylactide (PLA, or also known as polylactic acid or poly(lactic acid)). Accordingly, in some embodiments, when the polyhydroxyalkanoate is partially replaced by a polylactide, the filament suitable for three-dimensional printing comprises the aliphatic polyester, the aliphatic-aromatic polyester, the polyhydroxyalkanoate, and a polylactide. In some embodiments, when the polyhydroxyalkanoate is totally replaced by a polylactide, the filament comprises the aliphatic polyester, the aliphatic-aromatic polyester, and the polylactide. However, in embodiments where the polyhydroxyalkanoate is totally replaced by a polylactide, the filament does not contain a polyhydroxyalkanoate.

Optionally, the filament suitable for three-dimensional printing may further comprise at least one additive (one or more additives). For example, the filament may comprise at least one additive (or one or more additives) that is generally known to be used in a filament for three-dimensional printing. The optional additives may include, but are not limited to, additives such as a flame retardant, a matting agent, a marker for authentication (e.g., a fluorescence marker), an antimicrobial agent, a colorant, a plasticizer, a filler, and any combination thereof.

Preferably, the filament suitable for three-dimensional printing further comprises a flame retardant, for example, a flame retardant such as a phosphate. The term “phosphate” as used herein refers to a salt comprising an anion selected from the group consisting of [H₂PO₄]⁻, [HPO₄]²⁻ and [PO₄]³⁻. Preferably, the cation is ammonium [NH₄]⁺. Accordingly, in preferred embodiments, the flame retardant is selected from the group consisting of ammonium dihydrogenphosphate ([NH₄][H₂PO₄]), di-ammonium hydrogenphosphate ([NH₄]₂[HPO₄]), triammonium phosphate ([NH₄]₃[PO₄]) and any combination thereof. More preferably, the flame retardant is selected from the group consisting of ammonium dihydrogenphosphate ([NH₄][H₂PO₄]), di-ammonium hydrogenphosphate ([NH₄]₂[HPO₄]) and any combination thereof. More preferably, the flame retardant is ammonium dihydrogenphosphate ([NH₄][H₂PO₄]) or di-ammonium hydrogenphosphate ([NH₄]₂[HPO₄]). Still more preferably, the flame retardant is di-ammonium hydrogenphosphate ([NH₄]₂[HPO₄]). Alternatively, or in addition, the flame retardant may be a polyphosphate. “Polyphosphates” are salts or esters of polymeric oxyanions formed from tetrahedral PO₄ (phosphate) structural units linked together by sharing oxygen atoms. Preferably, when the flame retardant is a polyphosphate, the flame retardant is ammonium polyphosphate.

The filament suitable for three-dimensional printing may comprise the flame retardant in an amount of from 0.01 to 5% by weight, based on 100% by weight on the total weight of the filament. Preferably, the filament comprises the flame retardant in an amount of from 0.1 to 4% by weight, based on 100% by weight of the total weight of the filament. More preferably, the filament comprises the flame retardant in an amount of from 0.2% to 3% by weight, based on 100% by weight of the total weight of the filament. Still more preferably, the filament comprises the flame retardant in an amount of from 0.3 to 3% by weight, based on 100% by weight of the total weight of the filament. Even more preferably, the filament comprises the flame retardant in an amount of from 0.3 to 2% by weight, based on 100% by weight of the total weight of the filament. In particular, the foregoing ranges can be applied when the flame retardant is a phosphate or a polyphosphate, preferably, when the flame retardant is di-ammonium hydrogenphosphate ([NH₄]₂[HPO₄]).

Optionally, the filament suitable for three-dimensional printing may (also) comprise a matting agent. Any matting agent known to a person skilled in the art can be used, such as a typical matting agent used in filaments suitable for three-dimensional printing. As illustrative example, the matting agent may be zinc sulfide.

Optionally, the filament for three-dimensional printing may (also) comprise a marker suitable for authentication. As an illustrative non-limiting example, the marker suitable for authentication can be a fluorescence marker. Fluorescence of the filament and also a three-dimensionally printed article prepared from the filament can then be detected by a suitable device and taken for authentication. For example, a fluorescence marker available from Polysecure, Freiburg im Breisgau, Germany can be used. The marker suitable for authentication is generally used only in small amounts, which usually do not alter the properties of the filament. Typically, the amount of the marker suitable for authentication in the filament is in the ppb (parts per billion) range.

Optionally, the filament suitable for three-dimensional printing may (also) include an antimicrobial agent. Any antimicrobial agent known to a person skilled in the art, which is suitable for being used in a filament for three-dimensional printing, can be used. As an illustrative non-limiting example, the antimicrobial agent may be zinc encapsulated with polyethylene terephthalate. Such antimicrobial agent, e.g., is commercially available from Smartpolymer GmbH, Rudolstadt, Germany, under the trade name SMARTZINC 213 PET Hot Melt.

Optionally, the filament for three-dimensional printing may (also) include a plasticizer. Any plasticizer known to a person skilled in the art, which is suitable for being used in a filament for three-dimensional printing, can be used. As an illustrative example, the plasticizer may be polycaprolactone. In particular, polycaprolactone is biodegradable. In some embodiments, the filament may comprise polycaprolactone in an amount of 1% by weight or less based on 100% by weight of the total weight of the filament. It has turned out that a filament comprising 1% by weight or less of polycaprolactone exhibits satisfactory softness and flexibility. However, it is noted that a filament suitable for three-dimensional printing in accordance with the present invention, which comprises an aliphatic polyester, an aliphatic-aromatic polyester and a polyhydroxyalkanoate, may usually already exhibit satisfactory softness and flexibility without addition of polycaprolactone or other plasticizers.

Optionally, the filament may (also) include a colorant. Any colorant providing a desired color, which is suitable for being used in a filament suitable for three-dimensional printing, may be used. As illustrative examples, the colorant may be an inorganic or an organic pigment.

Optionally, the filament printing may (also) include a filler. Any filler known to a person skilled in the art, which is suitable for being used in a filament for three-dimensional printing, may be used, with biodegradable fillers being preferred. As illustrative example, the (biodegrable) filler may be lignin or may comprise lignin. Preferably, the lignin is oxygen-bleached lignin. Oxygen-bleaching of lignin is an environmentally friendly process, compared to traditional chlorine bleaching.

A person skilled in the art will readily select suitable amount(s) of the additive(s) to be comprised in the filament. As an illustrative example, the filament suitable for three-dimensional printing may comprise a total amount of additive(s) of 15% by weight or less, based on 100% by weight of the total weight of the filament. The filament may comprise a total amount of additive(s) of 10% by weight or less, based on 100% by weight of the total weight of the filament. Preferably, the filament comprises a total amount of additives of 7% by weight or less, based on 100% by weight of the total weight of the filament. More preferably, the filament comprises a total amount of additives of 5% by weight or less, based on 100% by weight of the total weight of the filament. Still more preferably, the filament comprises a total amount of additives of 4% by weight or less, based on 100% by weight of the total weight of the filament. Even more preferably, the filament comprises a total amount of additives of 3 to 4% by weight, based on 100% by weight of the total weight of the filament. It is preferred that the filament comprises a total amount of additives of 7% by weight or less, more preferably 3 to 4% by weight, each based on 100% by weight of the total weight of the filament, in order to achieve a stiffness of the filament which is useful for three-dimensional printing.

The filament may have any diameter which is suitable for being used in a 3D printer. Accordingly, a diameter of the filament suitable for three-dimensional printing may be 1.0 mm or more. Preferably, a diameter of the filament may be 1.5 mm or more. More preferably, a diameter of the filament may be 1.6 mm or more. Even more preferably, a diameter of the filament may be 1.7 mm or more. In addition, or alternatively, a diameter of the filament suitable for three-dimensional printing may be 5.0 mm or less. Preferably, a diameter of the filament may be 4.0 mm or less. More preferably, a diameter of the filament may be 3.5 mm or less. Even more preferably, a diameter of the filament may be 3.0 mm or less. In some embodiments, a diameter of the filament suitable for three-dimensional printing may be within a range of from 1.70 mm to 1.80 mm. In some embodiments, a diameter of the filament suitable for three-dimensional printing may be within a range of from 2.80 mm to 3.05 mm.

Preferably, the filament suitable for three-dimensional printing is biodegradable. More preferably, the filament is biodegradable in accordance with EN 13432. Accordingly, the filament may be considered as biodegradable in accordance with EN 13432 when the filament has a DIN EN 13432 percentage degree of biodegradation equal to at least 90% after the prescribed periods of time. The general effect of biodegradability is that the filament decomposes within an appropriate and verifiable interval. Degradation may be effected enzymatically, hydrolytically, oxidatively and/or through action of electromagnetic radiation, for example UV radiation, and may be predominantly due to the action of microorganisms such as bacteria, yeasts, fungi and algae. Biodegradability can be quantified, for example, by the filament being mixed with compost and stored for a certain time. For example, CO₂-free air can be flowed through ripened compost during composting and the ripened compost subjected to a defined temperature program. Biodegradability can be, for example, defined via the ratio of the net CO₂ released by the sample (after deduction of the CO₂ released by the compost without sample) to the maximum amount of CO₂ releasable by the sample (reckoned from the carbon content of the sample), as a percentage degree of biodegradation. A biodegradable filament typically shows clear signs of degradation, such as fungal growth, cracking and holing, after just a few days of composting. Other methods of determining biodegradability are described, for example, in ASTM D 5338 and ASTM D 6400. Also preferably, a three-dimensionally printed article, which is obtainable or being obtained by subjecting a filament suitable for three-dimensional printing according to the invention to three-dimensional printing, is biodegradable. More preferably, the three-dimensionally printed article is biodegradable in accordance with EN 13432.

In some embodiments, the filament suitable for three-dimensional printing is not a hollow fiber or a hollow filament. The term “hollow fiber”, as used herein and known in the art, in general refers to any fiber which has one or more cavities in cross section. The term “cavity”, as used herein, in general denotes a hollow space which is present within the cross section of the fiber. The cavity may be filled with gas, such as e.g. with air. As an illustrative example, the hollow fiber may have one continuous cavity in cross section. However, it is also possible that the hollow fiber comprises more than one cavity (e.g., 2, 3, 4, 5, 6, 7, 8, 9, 10, 11, 12, 13, 14, 15, 16, 17, 18, 19, 20 or even more cavities). The hollow fiber may, in addition to the one or more cavities, further comprise one or more portions having a compact structure. As used herein, the term “compact structure”, which may be also referred to as a “condensed structure”, in general denotes that the material of the fiber is present in a substantially dense or condensed form, in particular when compared to a cavity of the hollow fiber. The term “compact structure” or “condensed structure” may also include that the respective structure contains pore(s) which, however, are in general significantly smaller than a cavity of the hollow fiber. A hollow fiber which comprises both cavities and compact (or condensed) structures may be also denoted as a segmented fiber, or a segmented hollow fiber. As an illustrative example, the hollow fiber may comprise cavities and compact structures which are arranged in an alternating pattern along the longitudinal direction of the fiber. All of the foregoing definitions for a “hollow fiber” equally apply to a “hollow filament”.

In particular, in some embodiments, the filament suitable for three-dimensional printing is not a fiber as described in international patent application PCT/EP2022/075084. Fibers described in PCT/EP2022/075084 are also described in the following. Accordingly, in some embodiments, the filament suitable for three-dimensional printing is not:
A fiber being obtainable or being obtained by a method comprising:
spinning a melt comprising an aliphatic polyester, an aliphatic-aromatic polyester, and a polyhydroxyalkanoate through a hollow fiber spinning nozzle to obtain a precursor fiber; and
cooling the precursor fiber under a temperature gradient, thereby obtaining the fiber.
A fiber obtainable or being obtained by this method comprises two kinds of portions, wherein the one kind of portions are thicker portions and the other kinds of portions are thinner portions, and has a structure as described herein in the following. Accordingly, in some embodiments, the filament suitable for three-dimensional printing is not:
A fiber being made from a mixture comprising an aliphatic polyester, an aliphatic-aromatic polyester, and a polyhydroxyalkanoate,
wherein the fiber comprises, in a longitudinal direction, two kinds of portions, wherein the one kind of portions are thicker portions and the other kinds of portions are thinner portions, wherein said thicker portions and thinner portions extend in a vertical direction relative to the longitudinal direction of the fiber, and wherein an extension in the vertical direction of a thicker portion is greater than an extension in the vertical direction of a thinner portion;
wherein at least a part of the thicker portions has a cavity, and at least a part of the thinner portions has a compact structure. In some embodiments, the filament suitable for three-dimensional printing is not:
A hollow fiber being made from a mixture comprising an aliphatic polyester, an aliphatic-aromatic polyester, and a polyhydroxyalkanoate. In some embodiments, the filament suitable for three-dimensional printing is not a segmented fiber or a segmented hollow fiber.

In some embodiments, the filament suitable for three-dimensional printing is a solid filament. In some embodiments, the filament suitable for three-dimensional printing is a non-hollow filament. The term “solid filament”, or also denoted as “non-hollow filament”, as used herein and known in the art, in general refers to any filament wherein the material of the filament is present in a substantially dense or condensed form, and which has no cavities, as described herein for a hollow filament or a hollow fiber. However, the term “solid filament”, or “non-hollow filament”, does not exclude that the filament may contain a few pore(s) which, however, are in general significantly smaller than a cavity of a hollow filament or a hollow fiber.

It is desirable to stably store the filament for three-dimensional printing and to stably supply the filament to the three-dimensional printer. It is hence preferable that the filament of the invention is packaged, as a roll obtained by winding the filament on a bobbin or that the roll is housed in a cartridge, from the standpoints of long-term storage, stable drawing out, protection against environmental factors including ultraviolet light, prevention of twisting, etc. Accordingly, the present invention also relates to a roll comprising a filament suitable for three-dimensional printing according to the invention. The present invention also relates to a cartridge suitable for a three-dimensional printer, comprising a filament suitable for three-dimensional printing according to the invention. Illustrative examples of a cartridge include one which not only contains a roll obtained by winding the filament on a bobbin but also uses a vapor proofing material or moisture absorbent inside and which has a structure in which at least the parts other than the orifice part for drawing out the filament is sealed. Either a roll obtained by winding the filament for three-dimensional printing on a bobbin, or a cartridge including the roll is usually installed in or around the three-dimensional printer, and the filament is continuously introduced from the cartridge into the three-dimensional printer during the 3D printing process.

The present invention also relates to a three-dimensionally printed article, obtainable or being obtained by subjecting a filament suitable for three-dimensional printing according to the invention to three-dimensional printing, thereby obtaining the three-dimensionally printed article. The present invention also relates to a three-dimensionally printed article comprising an aliphatic polyester, an aliphatic-aromatic polyester, and the polyhydroxyalkanoate. A three-dimensionally printed article can be obtained by using the filament suitable for three-dimensional printing for molding with a three-dimensional printer. In general, a conventional three-dimensional printer known in the art can be used. Examples of the molding method applied by the three-dimensional printer include a material extrusion method (ME method), a powder sintering method, an inkjet method, and a stereolithography method (SLA method). Preferably, the filament of the present invention is used for the material extrusion method. The three-dimensionally printed article is not particularly limited. In general, any article having a desired shape may be prepared from the filament in a three-dimensional printing process. Illustrative examples for three-dimensionally printed articles obtainable or being obtained from a filament according to the invention may include products for stationary; toys; covers of cell phones, smartphones, etc.; parts such as a grip; school teaching materials; home electric appliances; parts for automobiles, motorcycles, bicycles, etc.; electric/electronic devices; materials for agriculture; materials for gardening; materials for fisheries; materials for civil engineering/construction; and medical supplies. In some embodiments, the three-dimensionally printed article may be a plastic card, such as e.g. a plastic card in the format of a credit card.

The present invention also relates to a method of preparing a filament suitable for three-dimensional printing according to the invention, comprising extruding a melt comprising an aliphatic polyester, an aliphatic-aromatic polyester, and a polyhydroxyalkanoate into the form of a filament, thereby obtaining the filament. The filament may be further defined as described herein for any filament suitable for three-dimensional printing.

A melt for preparing the filament can be produced using any method for producing a melt which is known to a person skilled in the art. As an illustrative example, the aliphatic polyester, aliphatic-aromatic polyester and polyhydroxyalkanoate can be mixed in the unmolten state, e.g. by mixing granules of the polymers, optionally with addition of one or more further additives. Optionally, the polymers and, if present, the additive(s) may be dried before the mixing and the preparation of the melt. Then, for preparing the melt, the mixture can be heated to or above the melting point(s) of the polymers. As an illustrative example, the mixing and heating may be carried out in an extruder. In some embodiments, the melt may have a temperature, in particular before extrusion, of from 200° C. to 260°, preferably of from 220° C. to 250° C., more preferably of from 230° C. to 250° C., still more preferably of from 230° C. to 240° C. As an illustrative example, the melt may be heated to a temperature of 235° C. The melt is then extruded into the shape of a filament. In order to obtain a filament, the melt can be extruded though a nozzle or any other orifice having a suitable shape, in particular a circular shape. Optionally, after extrusion the filament can be cooled, e.g. by air cooling or water cooling. Suitable cooling means/devices for cooling are generally known and readily selected by a person skilled in the art.

Preferably, the melt comprises the aliphatic polyester in an amount of from 30 to 70% by weight, based on 100% by weight of the combined amount of the aliphatic polyester, the aliphatic-aromatic polyester, and the polyhydroxyalkanoate. More preferably, the melt comprises the aliphatic polyester in an amount of from 35 to 65% by weight, based on 100% by weight of the combined amount of the aliphatic polyester, the aliphatic-aromatic polyester, and the polyhydroxyalkanoate. Still more preferably, the melt comprises the aliphatic polyester in an amount of from 40 to 60% by weight or 42 to 62% by weight, based on 100% by weight of the combined amount of the aliphatic polyester, the aliphatic-aromatic polyester, and the polyhydroxyalkanoate. Even more preferably, the melt comprises the aliphatic polyester in an amount of from 45 to 55% by weight, based on 100% by weight of the combined amount of the aliphatic polyester, the aliphatic-aromatic polyester, and the polyhydroxyalkanoate. In particular, these ranges can be applied when the aliphatic polyester is a polybutylene succinate. In a preferred embodiment, the melt comprises 52% by weight of a polybutylene succinate based on 100% by weight of the combined amount of the polybutylene succinate, an aliphatic aromatic polyester and a polyhydroxyalkanoate.

Preferably, the melt comprises the aliphatic-aromatic polyester in an amount of from 10 to 60% by weight, based on 100% by weight of the combined amount of the aliphatic polyester, the aliphatic-aromatic polyester, and the polyhydroxyalkanoate. More preferably, the melt comprises the aliphatic-aromatic polyester in an amount of from 20 to 50% by weight, based on 100% by weight of the combined amount of the aliphatic polyester, the aliphatic-aromatic polyester, and the polyhydroxyalkanoate. Still more preferably, the melt comprises the aliphatic-aromatic polyester in an amount of from 25 to 40% by weight or 26 to 46% by weight, based on 100% by weight of the combined amount of the aliphatic polyester, the aliphatic-aromatic polyester, and the polyhydroxyalkanoate. Even more preferably, the melt comprises the aliphatic-aromatic polyester in an amount of from 30 to 40% by weight, based on 100% by weight of the combined amount of the aliphatic polyester, the aliphatic-aromatic polyester, and the polyhydroxyalkanoate. In particular, these ranges can be applied when the aliphatic-aromatic polyester is a polybutylene adipate terephthalate (PBAT). In a preferred embodiment, the melt comprises 36% by weight polybutylene adipate terephthalate (PBAT) based on 100% by weight of the combined amount of an aliphatic polyester, the polybutylene adipate terephthalate (PBAT) and a polyhydroxyalkanoate.

Preferably, the melt comprises the polyhydroxyalkanoate in an amount of from 1 to 25% by weight, based on 100% by weight of the combined amount of the aliphatic polyester, the aliphatic-aromatic polyester, and the polyhydroxyalkanoate. More preferably, the melt comprises the polyhydroxyalkanoate in an amount of from 2 to 22% by weight, based on 100% by weight of the combined amount of the aliphatic polyester, the aliphatic-aromatic polyester, and the polyhydroxyalkanoate. Still more preferably, the melt comprises the polyhydroxyalkanoate in an amount of 3 to 20 by weight, based on 100% by weight of the combined amount of the aliphatic polyester, the aliphatic-aromatic polyester, and the polyhydroxyalkanoate. Still more preferably, the melt comprises the polyhydroxyalkanoate in an amount of from 3 to 18% by weight, based on 100% by weight of the combined amount of the aliphatic polyester, the aliphatic-aromatic polyester, and the polyhydroxyalkanoate. Even more preferably, the melt comprises the polyhydroxyalkanoate in an amount of from 5 to 15% by weight, based on 100% by weight of the combined amount of the aliphatic polyester, the aliphatic-aromatic polyester, and the polyhydroxyalkanoate. In particular, these ranges can be applied when the polyhydroxyalkanoate is a polyhydroxybutyrate-co-hydroxyhexanoate, preferably a poly(3-hydroxybutyrate-co-3-hydroxyhexanoate) (PHBH). Preferably, when the polyhydroxyalkanoate is a polyhydroxybutyrate-co-hydroxyhexanoate, preferably a poly(3-hydroxybutyrate-co-3-hydroxyhexanoate) (PHBH), the melt comprises 20% by weight or less, more preferably 18% by weight or less of the polyhydroxybutyrate-co-hydroxyhexanoate, preferably a poly(3-hydroxybutyrate-co-3-hydroxyhexanoate) (PHBH) based on 100% by weight of the combined amount of an aliphatic polyester, an aliphatic-aromatic polyester and the polyhydroxybutyrate-co-hydroxyhexanoate, preferably the poly(3-hydroxybutyrate-co-3-hydroxyhexanoate) (PHBH).

The ranges for the amounts of the aliphatic polyester, the aliphatic-aromatic polyester and the polyhydroxyalkanoate may be also combined with each other. Accordingly, as illustrative examples, the melt may comprise the aliphatic polyester in an amount of from 42 to 62% by weight, preferably 45 to 55% by weight, the melt may comprise the aliphatic-aromatic polyester in an amount of from 26 to 46% by weight, preferably 30 to 40% by weight, and the melt may comprise the polyhydroxybutyrate in an amount of from 2 to 22% by weight, preferably 3 to 20% by weight, more preferably 3 to 18% by weight, each based on 100% by weight of the combined amount of the aliphatic polyester, the aliphatic-aromatic polyester and the polyhydroxyalkanoate. A person skilled in the art will readily select suitable amounts of one or more of the polymer(s) within the ranges provided herein, so that the total amount of 100% by weight of the combined amount of the aliphatic polyester, the aliphatic-aromatic polyester and the polyhydroxyalkanoate is not exceeded. In particular, these ranges can be applied when the aliphatic polyester is a polybutylene succinate, the aliphatic aromatic polyester is a polybutylene adipate terephthalate, and the polyhydroxyalkanoate is a polyhydroxybutyrate-co-hydroxyhexanoate, preferably a poly(3-hydroxybutyrate-co-3-hydroxyhexanoate) (PHBH). In a very preferred embodiment, the melt comprises 52% by weight of a polybutylene succinate, 36% by weight of a polybutylene adipate terephthalate and 12% by weight of a polyhydroxybutyrate-co-hydroxyhexanoate, preferably a poly(3-hydroxybutyrate-co-3-hydroxyhexanoate) (PHBH), each based on 100% by weight of the combined amount of the polybutylene succinate, the polybutylene adipate terephthalate and the polyhydroxybutyrate-co-hydroxyhexanoate, preferably the poly(3-hydroxybutyrate-co-3-hydroxyhexanoate) (PHBH).

In some embodiments, the polyhydroxyalkanoate may be partially or totally replaced by a polylactide (PLA, or also known as polylactic acid or poly(lactic acid)). Accordingly, in some embodiments, when the polyhydroxyalkanoate is partially replaced by a polylactide, the melt comprises the aliphatic polyester, the aliphatic-aromatic polyester, the polyhydroxyalkanoate, and a polylactide. In some embodiments, when the polyhydroxyalkanoate is totally replaced by a polylactide, the melt comprises the aliphatic polyester, the aliphatic-aromatic polyester, and the polylactide. However, in embodiments where the polyhydroxyalkanoate is totally replaced by a polylactide, the melt does not contain a polyhydroxyalkanoate.

Optionally, the melt may further comprise at least one additive. For example, the melt may comprise at least one additive as generally known to be used in a filament suitable for three-dimensional printing. The optional additives may include, but are not limited to, an additive selected from the group consisting of a flame retardant, a matting agent, a marker for authentication (e.g., a fluorescence marker), an antimicrobial agent, a plasticizer, a colorant, a filler, and any combination thereof.

Preferably, the melt further comprises a flame retardant. More preferably, the flame retardant is a phosphate. In preferred embodiments, the flame retardant is selected from the group consisting of ammonium dihydrogenphosphate ([NH₄][H₂PO₄]), di-ammonium hydrogenphosphate ([NH₄]₂[HPO₄]), triammonium phosphate ([NH₄]₃[PO₄]) and any combination thereof. More preferably, the flame retardant is selected from the group consisting of ammonium dihydrogenphosphate ([NH₄][H₂PO₄]), di-ammonium hydrogenphosphate ([NH₄]₂[HPO₄]) and any combination thereof. More preferably, the flame retardant is ammonium dihydrogenphosphate ([NH₄][H₂PO₄]) or di-ammonium hydrogenphosphate ([NH₄]₂[HPO₄]). Still more preferably, the flame retardant is di-ammonium hydrogenphosphate ([NH₄]₂[HPO₄]). Alternatively, or in addition, the flame retardant may be a polyphosphate. Preferably, when the flame retardant is a polyphosphate, the flame retardant is ammonium polyphosphate.

The melt may comprise the flame retardant in an amount of from 0.01 to 5% by weight, based on 100% by weight of the total weight of the melt. Preferably, the melt comprises the flame retardant in an amount of from 0.1 to 4% by weight, based on 100% by weight of the total weight of the melt. More preferably, the melt comprises the flame retardant in an amount of from 0.2% to 3% by weight, based on 100% by weight of the total weight of the melt. Still more preferably, the melt comprises the flame retardant in an amount of from 0.3 to 3% by weight, based on 100% by weight of the total weight of the melt. Even more preferably, the melt comprises the flame retardant in an amount of from 0.3 to 2% by weight, based on 100% by weight of the total weight of the melt. In particular, the foregoing ranges can be applied when the flame retardant is a phosphate or a polyphosphate, preferably, when the flame retardant is di-ammonium hydrogenphosphate ([NH₄]₂[HPO₄]).

A person skilled in the art will readily select suitable amount(s) of the additive(s) to be comprised in the melt. As an illustrative example, the melt may comprise a total amount of additive(s) of 15% by weight or less, based on 100% by weight of the total weight of the melt. The melt may comprise a total amount of additive(s) of 10% by weight or less, based on 100% by weight of the total weight of the melt. Preferably, the melt comprises a total amount of additives of 7% by weight or less, based on 100% by weight of the total weight of the melt. More preferably, the melt comprises a total amount of additives of 5% by weight or less, based on 100% by weight of the total weight of the melt. Still more preferably, the melt comprises a total amount of additives of 4% by weight or less, based on 100% by weight of the total weight of the melt. Even more preferably, the melt comprises a total amount of additives of 3 to 4% by weight, based on 100% by weight of the total weight of the melt. It is preferred that the melt comprises a total amount of additives of 7% by weight or less, more preferably 3 to 4% by weight, each based on 100% by weight of the total weight of the melt, in order to achieve a stiffness of the filament which is useful for a filament suitable for three-dimensional printing.

In some embodiments, the melt is not extruded through a hollow fiber spinning nozzle to form the filament suitable for three-dimensional printing. The term “hollow fiber spinning nozzle”, as used herein, refers to any hollow fiber spinning nozzle generally known in the art. A merely illustrative example for a hollow fiber spinning nozzle is described, e.g., in EP 2 112 256, the whole content of which is hereby incorporated by reference.

In some embodiments, the method of preparing a filament suitable for three-dimensional printing is not a method of preparing a fiber as described in international patent application PCT/EP2022/075084. In particular, in some embodiments, the method of preparing a filament suitable for three-dimensional printing is not:
a method of preparing a fiber, comprising:
   spinning a melt comprising an aliphatic polyester, an aliphatic-aromatic polyester, and a polyhydroxyalkanoate through a hollow fiber spinning nozzle to obtain a precursor fiber; and
   cooling the precursor fiber under a temperature gradient, thereby obtaining the fiber.

The present invention also relates to a filament suitable for three-dimensional printing, obtainable or being obtained by a method of preparing a filament for three-dimensional printing according to the invention.

The present invention also relates to a use of a melt comprising an aliphatic polyester, an aliphatic-aromatic polyester, and a polyhydroxyalkanoate for the preparation of a filament suitable for three-dimensional printing, wherein the filament is as defined herein.

The present invention also relates to a use of a melt comprising an aliphatic polyester, an aliphatic-aromatic polyester, and a polyhydroxyalkanoate for the preparation of a filament suitable for three-dimensional printing.

### Mixture Comprising an Aliphatic Polyester, an Aliphatic-Aromatic Polyester and a Polyhydroxyalkanoate

The present invention also relates to a mixture comprising an aliphatic polyester, an aliphatic-aromatic polyester, and a polyhydroxyalkanoate. Such mixture can be used, e.g., for the preparation of a fiber or a filament suitable for three-dimensional printing according to the invention.

The aliphatic polyester, the aliphatic-aromatic polyester and the polyhydroxyalkanoate comprised in the mixture may be further defined as described herein, in particular as described herein for any fiber or any filament suitable for three-dimensional printing. In one very preferred embodiment, the aliphatic polyester is a polybutylene succinate (PBS), the aliphatic-aromatic polyester is a polybutylene adipate terephthalate (PBAT), and the polyalkoxyalkanoate is a poly(3-hydroxybutyrate-co-3-hydroxyhexanoate) (PHBH). Accordingly, the present invention also relates to a mixture comprising a polybutylene succinate (PBS), a polybutylene adipate terephthalate (PBAT), and a poly(3-hydroxybutyrate-co-3-hydroxyhexanoate) (PHBH).

In some embodiments, the mixture consists essentially of an aliphatic polyester, an aliphatic-aromatic polyester, and a polyhydroxyalkanoate. In some embodiments, the mixture consists essentially of a polybutylene succinate (PBS), a polybutylene adipate terephthalate (PBAT), and a poly(3-hydroxybutyrate-co-3-hydroxyhexanoate) (PHBH). In some embodiments, the mixture consists of an aliphatic polyester, an aliphatic-aromatic polyester, and a polyhydroxyalkanoate. In some embodiments, the mixture consists of a polybutylene succinate (PBS), a polybutylene adipate terephthalate (PBAT), and a poly(3-hydroxybutyrate-co-3-hydroxyhexanoate) (PHBH).

In the mixture, the aliphatic polyester, the aliphatic-aromatic polyester, and the polyhydroxyalkanoate may be present in the form of particles. Illustrative examples of particles, which can be used in the mixture, may be selected from the group consisting of granules, pellets, extrudates, beads, prills, and any combination thereof. Preferably, the aliphatic polyester, the aliphatic-aromatic polyester, and the polyhydroxyalkanoate is in the form of granules. In a very preferred embodiment, the mixture comprises a polybutylene succinate (PBS), a polybutylene adipate terephthalate (PBAT), and a poly(3-hydroxybutyrate-co-3-hydroxyhexanoate) (PHBH) in the form of granules. The present invention also relates to a granulate comprising a polybutylene succinate (PBS), a polybutylene adipate terephthalate (PBAT), and a poly(3-hydroxybutyrate-co-3-hydroxyhexanoate) (PHBH). In order to prepare a fiber or a filament suitable for three-dimensional printing, the mixture comprising particles of the polymers can be heated above the melting point(s) of the polymers. In some embodiments, the mixture can thus be present in form of a melt. The melt can be subjected to spinning a fiber, or extrusion into a filament suitable for three-dimensional printing, as described herein.

Preferably, the mixture comprises the aliphatic polyester in an amount of from 30 to 70% by weight, based on 100% by weight of the combined amount of the aliphatic polyester, the aliphatic-aromatic polyester, and the polyhydroxyalkanoate. More preferably, the mixture comprises the aliphatic polyester in an amount of from 35 to 65% by weight, based on 100% by weight of the combined amount of the aliphatic polyester, the aliphatic-aromatic polyester, and the polyhydroxyalkanoate. Still more preferably, the mixture comprises the aliphatic polyester in an amount of from 40 to 60% by weight or 42 to 62% by weight, based on 100% by weight of the combined amount of the aliphatic polyester, the aliphatic-aromatic polyester, and the polyhydroxyalkanoate. Even more preferably, the mixture comprises the aliphatic polyester in an amount of from 45 to 55% by weight, based on 100% by weight of the combined amount of the aliphatic polyester, the aliphatic-aromatic polyester, and the polyhydroxyalkanoate. In particular, these ranges can be applied when the aliphatic polyester is a polybutylene succinate. In a preferred embodiment, the mixture comprises 52% by weight of a polybutylene succinate based on 100% by weight of the combined amount of the polybutylene succinate, an aliphatic aromatic polyester and a polyhydroxyalkanoate.

Preferably, the mixture comprises the aliphatic-aromatic polyester in an amount of from 10 to 60% by weight, based on 100% by weight of the combined amount of the aliphatic polyester, the aliphatic-aromatic polyester, and the polyhydroxyalkanoate. More preferably, the mixture comprises the aliphatic-aromatic polyester in an amount of from 20 to 50% by weight, based on 100% by weight of the combined amount of the aliphatic polyester, the aliphatic-aromatic polyester, and the polyhydroxyalkanoate. Still more preferably, the mixture comprises the aliphatic-aromatic polyester in an amount of from 25 to 40% by weight or 26 to 46% by weight, based on 100% by weight of the combined amount of the aliphatic polyester, the aliphatic-aromatic polyester, and the polyhydroxyalkanoate. Even more preferably, the mixture comprises the aliphatic-aromatic polyester in an amount of from 30 to 40% by weight, based on 100% by weight of the combined amount of the aliphatic polyester, the aliphatic-aromatic polyester, and the polyhydroxyalkanoate. In particular, these ranges can be applied when the aliphatic-aromatic polyester is a polybutylene adipate terephthalate (PBAT). In a preferred embodiment, the mixture comprises 36% by weight polybutylene adipate terephthalate (PBAT) based on 100% by weight of the combined amount of an aliphatic polyester, the polybutylene adipate terephthalate (PBAT) and a polyhydroxyalkanoate.

Preferably, the mixture comprises the polyhydroxyalkanoate in an amount of from 1 to 25% by weight, based on 100% by weight of the combined amount of the aliphatic polyester, the aliphatic-aromatic polyester, and the polyhydroxyalkanoate. More preferably, the mixture comprises the polyhydroxyalkanoate in an amount of from 2 to 22% by weight, based on 100% by weight of the combined amount of the aliphatic polyester, the aliphatic-aromatic polyester, and the polyhydroxyalkanoate. Still more preferably, the mixture comprises the polyhydroxyalkanoate in an amount of 3 to 20 by weight, based on 100% by weight of the combined amount of the aliphatic polyester, the aliphatic-aromatic polyester, and the polyhydroxyalkanoate. Still more preferably, the mixture comprises the polyhydroxyalkanoate in an amount of from 3 to 18% by weight, based on 100% by weight of the combined amount of the aliphatic polyester, the aliphatic-aromatic polyester, and the polyhydroxyalkanoate. Even more preferably, the mixture comprises the polyhydroxyalkanoate in an amount of from 5 to 15% by weight, based on 100% by weight of the combined amount of the aliphatic polyester, the aliphatic-aromatic polyester, and the polyhydroxyalkanoate. In particular, these ranges can be applied when the polyhydroxyalkanoate is a polyhydroxybutyrate-co-hydroxyhexanoate, preferably a poly(3-hydroxybutyrate-co-3-hydroxyhexanoate) (PHBH). Preferably, when the polyhydroxyalkanoate is a polyhydroxybutyrate-co-hydroxyhexanoate, preferably a poly(3-hydroxybutyrate-co-3-hydroxyhexanoate) (PHBH), the mixture comprises 20% by weight or less, more preferably 18% by weight or less of the polyhydroxybutyrate-co-hydroxyhexanoate, preferably a poly(3-hydroxybutyrate-co-3-hydroxyhexanoate) (PHBH) based on 100% by weight of the combined amount of an aliphatic polyester, an aliphatic-aromatic polyester and the polyhydroxybutyrate-co-hydroxyhexanoate, preferably the poly(3-hydroxybutyrate-co-3-hydroxyhexanoate) (PHBH).

The ranges for the amounts of the aliphatic polyester, the aliphatic-aromatic polyester and the polyhydroxyalkanoate may be also combined with each other. Accordingly, as illustrative examples, the mixture may comprise the aliphatic polyester in an amount of from 42 to 62% by weight, preferably 45 to 55% by weight, the mixture may comprise the aliphatic-aromatic polyester in an amount of from 26 to 46% by weight, preferably 30 to 40% by weight, and the mixture may comprise the polyhydroxybutyrate in an amount of from 2 to 22% by weight, preferably 3 to 20% by weight, more preferably 3 to 18% by weight, each based on 100% by weight of the combined amount of the aliphatic polyester, the aliphatic-aromatic polyester and the polyhydroxyalkanoate. A person skilled in the art will readily select suitable amounts of one or more of the polymer(s) within the ranges provided herein, so that the total amount of 100% by weight of the combined amount of the aliphatic polyester, the aliphatic-aromatic polyester and the polyhydroxyalkanoate is not exceeded. In particular, these ranges can be applied when the aliphatic polyester is a polybutylene succinate, the aliphatic aromatic polyester is a polybutylene adipate terephthalate, and the polyhydroxyalkanoate is a polyhydroxybutyrate-co-hydroxyhexanoate, preferably a poly(3-hydroxybutyrate-co-3-hydroxyhexanoate) (PHBH). In a very preferred embodiment, the mixture comprises 52% by weight of a polybutylene succinate, 36% by weight of a polybutylene adipate terephthalate and 12% by weight of a polyhydroxybutyrate-co-hydroxyhexanoate, preferably a poly(3-hydroxybutyrate-co-3-hydroxyhexanoate) (PHBH), each based on 100% by weight of the combined amount of the polybutylene succinate, the polybutylene adipate terephthalate and the polyhydroxybutyrate-co-hydroxyhexanoate, preferably the poly(3-hydroxybutyrate-co-3-hydroxyhexanoate) (PHBH).

Optionally, the mixture may further comprise at least one additive. For example, the mixture may comprise at least one additive as generally known to be used in a textile fiber or in a filament suitable for three-dimensional printing. The optional additives may include, but are not limited to, an additive selected from the group consisting of a flame retardant, a matting agent, a marker for authentication (e.g., a fluorescence marker), an antimicrobial agent, a plasticizer, a colorant, a filler, and any combination thereof.

Preferably, the mixture further comprises a flame retardant. More preferably, the flame retardant is a phosphate. In preferred embodiments, the flame retardant is selected from the group consisting of ammonium dihydrogenphosphate ([NH₄][H₂PO₄]), di-ammonium hydrogenphosphate ([NH₄]₂[HPO₄]), triammonium phosphate ([NH₄]₃[PO₄]) and any combination thereof. More preferably, the flame retardant is selected from the group consisting of ammonium dihydrogenphosphate ([NH₄][H₂PO₄]), di-ammonium hydrogenphosphate ([NH₄]₂[HPO₄]) and any combination thereof. More preferably, the flame retardant is ammonium dihydrogenphosphate ([NH₄][H₂PO₄]) or di-ammonium hydrogenphosphate ([NH₄]₂[HPO₄]). Still more preferably, the flame retardant is di-ammonium hydrogenphosphate ([NH₄]₂[HPO₄]). Alternatively, or in addition, the flame retardant may be a polyphosphate. Preferably, when the flame retardant is a polyphosphate, the flame retardant is ammonium polyphosphate.

The mixture may comprise the flame retardant in an amount of from 0.01 to 5% by weight, based on 100% by weight of the total weight of the mixture. Preferably, the mixture comprises the flame retardant in an amount of from 0.1 to 4% by weight, based on 100% by weight of the total weight of the mixture. More preferably, the mixture comprises the flame retardant in an amount of from 0.2% to 3% by weight, based on 100% by weight of the total weight of the mixture. Still more preferably, the mixture comprises the flame retardant in an amount of from 0.3 to 3% by weight, based on 100% by weight of the total weight of the mixture. Even more preferably, the mixture comprises the flame retardant in an amount of from 0.3 to 2% by weight, based on 100% by weight of the total weight of the mixture. In particular, the foregoing ranges can be applied when the flame retardant is a phosphate or a polyphosphate, preferably, when the flame retardant is di-ammonium hydrogenphosphate ([NH₄]₂[HPO₄]).

A person skilled in the art will readily select suitable amount(s) of the additive(s) to be comprised in the mixture. As an illustrative example, the mixture may comprise a total amount of additive(s) of 15% by weight or less, based on 100% by weight of the total weight of the mixture. The mixture may comprise a total amount of additive(s) of 10% by weight or less, based on 100% by weight of the total weight of the mixture. Preferably, the mixture comprises a total amount of additives of 7% by weight or less, based on 100% by weight of the total weight of the mixture. More preferably, the mixture comprises a total amount of additives of 5% by weight or less, based on 100% by weight of the total weight of the mixture. Still more preferably, the mixture comprises a total amount of additives of 4% by weight or less, based on 100% by weight of the total weight of the mixture. Even more preferably, the mixture comprises a total amount of additives of 3 to 4% by weight, based on 100% by weight of the total weight of the mixture. It is preferred that the mixture comprises a total amount of additives of 7% by weight or less, more preferably 3 to 4% by weight, each based on 100% by weight of the total weight of the mixture, in order to achieve a stiffness which is useful for a textile fiber, or for a filament suitable for three-dimensional printing.

The present invention also relates to a use of a mixture comprising an aliphatic polyester, an aliphatic-aromatic polyester, and a polyhydroxyalkanoate for the preparation of a fiber, wherein the fiber is as defined herein.

The present invention also relates to a use of a mixture comprising an aliphatic polyester, an aliphatic-aromatic polyester, and a polyhydroxyalkanoate for the preparation of a fiber.

The present invention also relates to a use of a mixture comprising an aliphatic polyester, an aliphatic-aromatic polyester, and a polyhydroxyalkanoate for the preparation of a filament suitable for three-dimensional printing, wherein the filament is as defined herein.

The present invention also relates to a use of a mixture comprising an aliphatic polyester, an aliphatic-aromatic polyester, and a polyhydroxyalkanoate for the preparation of a filament suitable for three-dimensional printing.

It is noted that as used herein, the singular forms “a”, “an”, and “the”, include plural references unless the context clearly indicates otherwise. Thus, for example, reference to “a reagent” includes one or more of such different reagents and reference to “the method” includes reference to equivalent steps and methods known to those of ordinary skill in the art that could be modified or substituted for the methods described herein.

Unless otherwise indicated, the term “at least” preceding a series of elements is to be understood to refer to every element in the series. Those skilled in the art will recognize, or be able to ascertain using no more than routine experimentation, many equivalents to the specific embodiments of the invention described herein. Such equivalents are intended to be encompassed by the present invention.

The term “and/or” wherever used herein includes the meaning of “and”, “or” and “all or any other combination of the elements connected by said term”.

The term “less than” or in turn “greater than” does not include the concrete number. For example, “less than 20” means less than the number indicated. Similarly, “greater than” means greater than the indicated number, e.g., greater than 80% means greater than the indicated number of 80%.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integer or step. When used herein the term “comprising” can be substituted with the term “containing” or “including” or sometimes when used herein with the term “having”.

When used herein, “consisting of” excludes any element, step, or ingredient not specified in the claim element. When used herein, “consisting essentially of” does not exclude materials or steps that do not materially affect the basic and novel characteristics of the claim. In each instance herein any of the terms “comprising”, “consisting essentially of” and “consisting of” may be replaced with either of the other two terms.

The term “including” means “including but not limited to”. “Including” and “including but not limited to” are used interchangeably.

When used herein, the term “about” is understood to mean that there can be variation in the respective value or range (such as pH, concentration, percentage, molarity, time etc.) that can be up to 5%, up to 10% of the given value. For example, if a formulation comprises about 5 mg/ml of a compound, this is understood to mean that a formulation can have between 4.5 and 5.5 mg/ml.

It should be understood that this invention is not limited to the particular methodology, protocols, material, reagents, and substances, etc., described herein and as such can vary. The terminology used herein is for the purpose of describing particular embodiments only and is not intended to limit the scope of the present invention, which is defined solely by the claims.

All publications cited throughout the text of this specification (including all patents, patent application, scientific publications, instructions, etc.), whether supra or infra, are hereby incorporated by reference in their entirety. Nothing herein is to be construed as an admission that the invention is not entitled to antedate such disclosure by virtue of prior invention. To the extent the material incorporated by reference contradicts or is inconsistent with this specification, the specification will supersede any such material.

The content of all documents and patent documents cited herein is incorporated by reference in their entirety.

The invention is further characterized by the following items:
1. A fiber being made from a mixture comprising an aliphatic polyester, an aliphatic-aromatic polyester, and a polyhydroxyalkanoate.
2. The fiber of item 1, wherein the aliphatic polyester comprises an aliphatic C₂-C₂₀ dicarboxylic acid and an aliphatic C₂-C₁₂ diol.
3. The fiber of item 1 or 2, wherein the aliphatic polyester is selected from the group consisting of a polybutylene succinate (PBS), a polyethylene oxalate, a polyethylene malonate, a polyethylene succinate, a polypropylene oxalate, a polypropylene malonate, a polypropylene succinate, a polybutylene oxalate, a polybutylene malonate, a polybutylene succinate-co-adipate (PBSA), a polybutylene succinate-co-azelate (PBSAz), a polybutylene succinate-co-brassylate (PBSBr), and any combination thereof.
4. The fiber of any one of the preceding items, wherein the aliphatic polyester is selected from the group consisting of a polybutylene succinate (PBS), a polybutylene succinate-co-adipate (PBSA), a polybutylene succinate-co-azelate (PBSAz), a polybutylene succinate-co-brassylate (PBSBr), and any combination thereof.
5. The fiber of any one of the preceding items, wherein the aliphatic polyester is a polybutylene succinate (PBS).
6. The fiber of any one of the preceding items, wherein the fiber comprises the aliphatic polyester in an amount of from 30 to 70% by weight based on 100% by weight of the combined amount of the aliphatic polyester, the aliphatic-aromatic polyester, and the polyhydroxyalkanoate.
7. The fiber of any one of the preceding items, wherein the aliphatic-aromatic polyester comprises a C₂-C₁₂ aliphatic dicarboxylic acid, an aromatic dicarboxylic acid, and an aliphatic C₂-C₁₂ diol.
8. The fiber of any one of the preceding items, wherein the aliphatic-aromatic polyester is selected from the group consisting of a polybutylene adipate terephthalate (PBAT), a polybutylene succinate terephthalate (PBST), a polybutylene sebacate terephthalate (PBSeT), and any combination thereof.
9. The fiber of any one of the preceding items, wherein the aliphatic-aromatic polyester is a polybutylene adipate terephthalate (PBAT).
10. The fiber of any one of the preceding items, wherein the fiber comprises the aliphatic-aromatic in an amount of from 10 to 60% by weight based on 100% by weight of the combined amount of the aliphatic polyester, the aliphatic-aromatic polyester, and the polyhydroxyalkanoate.
11. The fiber of any one of the preceding items, wherein the polyhydroxyalkanoate comprises a C₃-C₁₈ hydroxyalkylcarboxylic acid.
12. The fiber of any one of the preceding items, wherein the polyhydroxyalkanoate is selected from the group consisting of a polyhydroxybutyrate-co-hydroxyhexanoate, a polyhydroxybutyrate, a polyhydroxyvalerate, a polyhydroxybutyrate-co-hydroxyvalerate, and any combination thereof.
13. The fiber of any one of the preceding items, wherein the polyhydroxyalkanoate is selected from the group consisting of a poly(3-hydroxybutyrate-co-3-hydroxyhexanoate) (PHBH), a poly-3-hydroxybutyrate (P3HB), a poly-4-hydroxybutyrate (P4HB), a poly-3-hydroxyvalerate (PHV), a poly(3-hydroxybutyrate-co-4-hydroxybutyrate), a poly(3-hydroxybutyrate-co-3-hydroxyvalerate) (PHBV), and any combination thereof.
14. The fiber of any one of the preceding items, wherein the polyhydroxyalkanoate is a polyhydroxybutyrate-co-hydroxyhexanoate.
15. The fiber of any one of the preceding items, wherein the polyhydroxyalkanoate is a poly(3-hydroxybutyrate-co-3-hydroxyhexanoate) (PHBH).
16. The fiber of any one of the preceding items, wherein the fiber comprises the polyhydroxyalkanoate in an amount of from 1 to 25% by weight based on 100% by weight of the combined amount of the aliphatic polyester, the aliphatic-aromatic polyester, and the polyhydroxyalkanoate.
17. The fiber of any one of the preceding items, wherein the fiber comprises the aliphatic polyester in an amount of from 42 to 62% by weight, the aromatic-aliphatic polyester in an amount of from 26 to 46% by weight, and the polyhydroxyalkanoate in an amount of from 2 to 22% by weight based on 100% by weight of the combined amount of the aliphatic polyester, the aromatic-aliphatic polyester, and the polyhydroxyalkanoate.
18. The fiber of any one of the preceding items, wherein the aliphatic polyester is a polybutylene succinate (PBS), the aliphatic-aromatic polyester is a polybutylene adipate terephthalate (PBAT), and the polyhydroxyalkanoate is a poly(3-hydroxybutyrate-co-3-hydroxhexanoate) (PHBH).
19. The fiber of any one of the preceding items, wherein the polyhydroxyalkanoate is partially or totally replaced by a polylactide.
20. The fiber of any one of the preceding items, wherein the fiber is a textile fiber.
21. The fiber of any one of the preceding items, wherein the fiber further comprises at least one additive.
22. The fiber of item 21, wherein the at least one additive is selected from the group consisting of a flame retardant, a matting agent, a fluorescence marker, an antimicrobial agent, a plasticizer, a filler, and any combination thereof.
23. The fiber of item 22, wherein the additive is a flame retardant.
24. The fiber of item 23, wherein the flame retardant is a phosphate selected from the group consisting of ammonium dihydrogenphosphate ([NH₄][H₂PO₄]), di-ammonium hydrogenphosphate ([NH₄]₂[HPO₄]), triammonium phosphate ([NH₄]₃[PO₄]), ammonium polyphosphate, and any combination thereof.
25. The fiber of item 24, wherein the phosphate is di-ammonium hydrogenphosphate ([NH₄]₂[HPO₄]).
26. The fiber of any one of items 22 to 25, wherein the fiber comprises the flame retardant in an amount of from 0.01 to 5% by weight, preferably 0.1 to 4% by weight, more preferably 0.2 to 3% by weight, still more preferably 0.3 to 2% by weight, based on 100% by weight of the total weight of the fiber.
27. The fiber of item 22, wherein the additive is a matting agent.
28. The fiber of item 27, wherein the matting agent is zinc sulfide.
29. The fiber of item 22, wherein the additive is a fluorescence marker.
30. The fiber of item 22, wherein the additive is an antimicrobial agent.
31. The fiber of item 30, wherein the antimicrobial agent is zinc encapsulated with polyethylene terephthalate.
32. The fiber of item 31, wherein the additive is a filler.
33. The fiber of item 32, wherein the filler is or comprises lignin.
34. The fiber of any one of items 21 to 33, wherein the fiber comprises a total amount of additive(s) of 15% by weight or less, preferably 10% by weight or less, more preferably 7% by weight or less, still more preferably 5% by weight or less, even more preferably 4% by weight or less, even more preferably 3 to 4% by weight, based on 100% by weight of the total weight of the fiber.
35. The fiber of any one of the preceding items, wherein the fiber titer is 0.5 to 8 den, preferably 0.8 to 6 den, more preferably 0.9 to 3 den, still more preferably 1.0 to 2 den, even more preferably 1.0 to 1.5 den, even more preferably 1.1 to 1.2 den.
36. The fiber of any one of the preceding items, wherein the fiber is a staple fiber.
37. The fiber of item 36, wherein the fiber has a staple length of from 2 to 80 mm, preferably of from 5 to 70 mm, more preferably of from 10 to 60 mm, still more preferably of from 15 to 50 mm, even more preferably of from 20 to 40 mm, even more preferably of from 22 to 35 mm, even more preferably of from 25 to 32 mm.
38. The fiber of any one of items 1 to 35, wherein the fiber is a filament.
39. The fiber of any one of the preceding items, wherein the fiber is biodegradable in accordance with EN 13432.
40. The fiber of any one of the preceding items, wherein the fiber is not:
   a fiber being obtainable or being obtained by a method comprising:
      spinning a melt comprising an aliphatic polyester, an aliphatic-aromatic polyester, and a polyhydroxyalkanoate through a hollow fiber spinning nozzle to obtain a precursor fiber; and
      cooling the precursor fiber under a temperature gradient, thereby obtaining the fiber.
41. The fiber of any one of the preceding items, wherein the fiber is not:
   a fiber being made from a mixture comprising an aliphatic polyester, an aliphatic-aromatic polyester, and a polyhydroxyalkanoate,
   wherein the fiber comprises, in a longitudinal direction, two kinds of portions, wherein the one kind of portions are thicker portions and the other kinds of portions are thinner portions, wherein said thicker portions and thinner portions extend in a vertical direction relative to the longitudinal direction of the fiber, and wherein an extension in the vertical direction of a thicker portion is greater than an extension in the vertical direction of a thinner portion;
   wherein at least a part of the thicker portions has a cavity, and at least a part of the thinner portions has a compact structure.
42. The fiber of any one of the preceding items, wherein the fiber is not:
   a hollow fiber being made from a mixture comprising an aliphatic polyester, an aliphatic-aromatic polyester, and a polyhodroxyalkanoate.
43. The fiber of any one of the preceding items, wherein the fiber is not a segmented fiber or a segmented hollow fiber.
44. A yarn comprising a fiber of any one of items 1 to 43.
45. A textile comprising a fiber of any one of items 1 to 43 or a yarn of claim 44.
46. The textile of item 45, wherein the textile is a clothing or a home textile.
47. The textile of item 46, wherein the clothing is selected from the group consisting of a shirt, a polo shirt, a pair of trouser, a jacket, underwear, socks, a coat, a shoe and shoe laces.
48. The textile of item 47, wherein the home textile is selected from the group consisting of a curtain, a rug, a blanket, a bedsheet, a duvet, a duvet cover, a cushion cover and a towel.
49. A method of preparing a fiber according to any one of items 1 to 43, comprising:
   spinning a melt comprising an aliphatic polyester, an aliphatic-aromatic polyester, and a polyhydroxyalkanoate through a spinning nozzle to obtain a precursor fiber; and
   cooling the precursor fiber, thereby obtaining the fiber.
49a. The method of item 49, wherein a temperature of the melt is in a range of from 200° C. to 260° C., preferably of from 220° C. to 250° C., more preferably of from 230° C. to 250° C., still more preferably of from 230 to 240° C.
50. The method of item 49, wherein the cooling is effected by air cooling.
51. The method of item 49 or 50, wherein the melt comprises the aliphatic polyester in an amount of from 30 to 70% by weight based on 100% by weight of the combined amount of the aliphatic polyester, the aliphatic-aromatic polyester, and the polyhydroxyalkanoate.
52. The method of any one of items 49 to 51, wherein the melt comprises the aliphatic-aromatic in an amount of from 10 to 60% by weight based on 100% by weight of the combined amount of the aliphatic polyester, the aliphatic-aromatic polyester, and the polyhydroxyalkanoate.
53. The method of any one of items 49 to 52, wherein the melt comprises the polyhydroxyalkanoate in an amount of from 1 to 25% by weight based on 100% by weight of the combined amount of the aliphatic polyester, the aliphatic-aromatic polyester, and the polyhydroxyalkanoate.
54. The method of any one of items 49 to 53, wherein the melt comprises the aliphatic polyester in an amount of from 42 to 62% by weight, the aromatic-aliphatic polyester in an amount of from 26 to 46% by weight, and the polyhydroxyalkanoate in an amount of from 2 to 22% by weight based on 100% by weight of the combined amount of the aliphatic polyester, the aromatic-aliphatic polyester, and the polyhydroxyalkanoate.
55. The method of any one of items 49 to 54, wherein the polyhydroxyalkanoate is partially or totally replaced by a polylactide.
56. The method of any one of items 49 to 55, wherein the melt further comprises at least an additive.
57. The method of item 56, wherein the at least additive is selected from the group consisting of a flame retardant, a matting agent, a fluorescence marker, an antimicrobial agent, a plasticizer, a filler, and any combination thereof.
58. The method of item 57, wherein the additive is a flame retardant.
59. The method of item 58, wherein the melt comprises the flame retardant in an amount of from 0.01 to 5% by weight, preferably 0.1 to 4% by weight, more preferably 0.2 to 3% by weight, still more preferably 0.3 to 2% by weight, based on 100% by weight of the total weight of the melt.
60. The method of any one of items 56 to 59, wherein the total amount of additive(s) is 15% by weight or less, preferably 10% by weight or less, more preferably 7% by weight or less, still more preferably 5% by weight or less, even more preferably 4% by weight or less, even more preferably 3 to 4% by weight, based on 100% by weight of the total weight of the melt.
61. The method of any one of items 49 to 60, wherein the fiber is prepared as a staple fiber.
62. The method of any one of items 49 to 60, wherein the fiber is prepared as a filament.
63. The method of any one of items 49 to 62, wherein the spinning nozzle is not a hollow fiber spinning nozzle.
64. The method of any one of items 49 to 63, wherein the method is not:
   a method of preparing a fiber, comprising:
      spinning a melt comprising an aliphatic polyester, an aliphatic-aromatic polyester, and a polyhydroxyalkanoate through a hollow fiber spinning nozzle to obtain a precursor fiber; and
      cooling the precursor fiber under a temperature gradient, thereby obtaining the fiber.
65. A fiber obtainable or being obtained by a method according to any one of items 49 to 64.
66. Use of a melt comprising an aliphatic polyester, an aliphatic-aromatic polyester, and a polyhydroxyalkanoate for the preparation of a fiber, wherein the fiber is defined as in any one of items 1 to 43.
67. Use of a melt comprising an aliphatic polyester, an aliphatic-aromatic polyester, and a polyhydroxyalkanoate for the preparation of a fiber.
68. Use of a mixture comprising an aliphatic polyester, an aliphatic-aromatic polyester, and a polyhydroxyalkanoate for the preparation of a fiber, wherein the fiber is defined as in any one of items 1 to 43.
69. Use of a mixture comprising an aliphatic polyester, an aliphatic-aromatic polyester, and a polyhydroxyalkanoate for the preparation of a fiber.
70. A filament suitable for three-dimensional printing being made from a mixture comprising an aliphatic polyester, an aliphatic-aromatic polyester, and a polyhydroxyalkanoate.
71. The filament of item 70, wherein the aliphatic polyester comprises an aliphatic C₂-C₂₀ dicarboxylic acid and an aliphatic C₂-C₁₂ diol.
72. The filament of item 70 or 71, wherein the aliphatic polyester is selected from the group consisting of a polybutylene succinate (PBS), a polyethylene oxalate, a polyethylene malonate, a polyethylene succinate, a polypropylene oxalate, a polypropylene malonate, a polypropylene succinate, a polybutylene oxalate, a polybutylene malonate, a polybutylene succinate-co-adipate (PBSA), a polybutylene succinate-co-azelate (PBSAz), a polybutylene succinate-co-brassylate (PBSBr), and any combination thereof.
73. The filament of any one of items 70 to 72, wherein the aliphatic polyester is selected from the group consisting of a polybutylene succinate (PBS), a polybutylene succinate-co-adipate (PBSA), a polybutylene succinate-co-azelate (PBSAz), a polybutylene succinate-co-brassylate (PBSBr), and any combination thereof.
74. The filament of any one of items 70 to 73, wherein the aliphatic polyester is a polybutylene succinate (PBS).
75. The filament of any one of items 70 to 74, wherein the filament comprises the aliphatic polyester in an amount of from 30 to 70% by weight based on 100% by weight of the combined amount of the aliphatic polyester, the aliphatic-aromatic polyester, and the polyhydroxyalkanoate.
76. The filament of any one of items 70 to 75, wherein the aliphatic-aromatic polyester comprises a C₂-C₁₂ aliphatic dicarboxylic acid, an aromatic dicarboxylic acid, and an aliphatic C₂-C₁₂ diol.
77. The filament of any one of items 70 to 76, wherein the aliphatic-aromatic polyester is selected from the group consisting of a polybutylene adipate terephthalate (PBAT), a polybutylene succinate terephthalate (PBST), a polybutylene sebacate terephthalate (PBSeT), and any combination thereof.
78. The filament of any one of items 70 to 77, wherein the aliphatic-aromatic polyester is a polybutylene adipate terephthalate (PBAT).
79. The filament of any one of items 70 to 78, wherein the filament comprises the aliphatic-aromatic in an amount of from 10 to 60% by weight based on 100% by weight of the combined amount of the aliphatic polyester, the aliphatic-aromatic polyester, and the polyhydroxyalkanoate.
80. The filament of any one of items 70 to 79, wherein the polyhydroxyalkanoate comprises a C₃-C₁₈ hydroxyalkylcarboxylic acid.
81. The filament of any one of items 70 to 80, wherein the polyhydroxyalkanoate is selected from the group consisting of a polyhydroxybutyrate-co-hydroxyhexanoate, a polyhydroxybutyrate, a polyhydroxyvalerate, a polyhydroxybutyrate-co-hydroxyvalerate, and any combination thereof.
82. The filament of any one of items 70 to 81, wherein the polyhydroxyalkanoate is selected from the group consisting of a poly(3-hydroxybutyrate-co-3-hydroxyhexanoate) (PHBH), a poly-3-hydroxybutyrate (P3HB), a poly-4-hydroxybutyrate (P4HB), a poly-3-hydroxyvalerate (PHV), a poly(3-hydroxybutyrate-co-4-hydroxybutyrate), a poly(3-hydroxybutyrate-co-3-hydroxyvalerate) (PHBV), and any combination thereof.
83. The filament of any one of items 70 to 82, wherein the polyhydroxyalkanoate is a polyhydroxybutyrate-co-hydroxyhexanoate.
84. The filament of any one of items 70 to 83, wherein the polyhydroxyalkanoate is a poly(3-hydroxybutyrate-co-3-hydroxyhexanoate) (PHBH).
85. The filament of any one of items 70 to 84, wherein the filament comprises the polyhydroxyalkanoate in an amount of from 1 to 25% by weight based on 100% by weight of the combined amount of the aliphatic polyester, the aliphatic-aromatic polyester, and the polyhydroxyalkanoate.
86. The filament of any one of items 70 to 85, wherein the filament comprises the aliphatic polyester in an amount of from 42 to 62% by weight, the aromatic-aliphatic polyester in an amount of from 26 to 46% by weight, and the polyhydroxyalkanoate in an amount of from 2 to 22% by weight based on 100% by weight of the combined amount of the aliphatic polyester, the aromatic-aliphatic polyester, and the polyhydroxyalkanoate.
87. The filament of any one of items 70 to 86, wherein the aliphatic polyester is a polybutylene succinate (PBS), the aliphatic-aromatic polyester is a polybutylene adipate terephthalate (PBAT), and the polyhydroxyalkanoate is a poly(3-hydroxybutyrate-co-3-hydroxhexanoate) (PHBH).
88. The filament of any one of items 70 to 87, wherein the polyhydroxyalkanoate is partially or totally replaced by a polylactide.
89. The filament of any one of items 70 to 88, wherein the fiber further comprises at least one additive.
90. The filament of item 89, wherein the at least one additive is selected from the group consisting of a flame retardant, a matting agent, a fluorescence marker, an antimicrobial agent, a plasticizer, a filler, and any combination thereof.
91. The filament of item 90, wherein the additive is a flame retardant.
92. The filament of item 91, wherein the flame retardant is a phosphate selected from the group consisting of ammonium dihydrogenphosphate ([NH₄][H₂PO₄]), di-ammonium hydrogenphosphate ([NH₄]₂[HPO₄]), triammonium phosphate ([NH₄]₃[PO₄]), ammonium polyphosphate, and any combination thereof.
93. The filament of item 92, wherein the phosphate is di-ammonium hydrogenphosphate ([NH₄]₂[HPO₄]).
94. The filament of any one of items 90 to 93, wherein the fiber comprises the flame retardant in an amount of from 0.01 to 5% by weight, preferably 0.1 to 4% by weight, more preferably 0.2 to 3% by weight, still more preferably 0.3 to 2% by weight, based on 100% by weight of the total weight of the filament.
95. The filament of item 90, wherein the additive is a matting agent.
96. The filament of item 95, wherein the matting agent is zinc sulfide.
97. The filament of item 90, wherein the additive is a fluorescence marker.
98. The filament of item 90, wherein the additive is an antimicrobial agent.
99. The filament of item 98, wherein the antimicrobial agent is zinc encapsulated with polyethylene terephthalate.
100. The filament of item 90, wherein the additive is a filler.
101. The filament of item 100, wherein the filler is or comprises lignin.
102. The filament of any one of items 89 to 101, wherein the filament comprises a total amount of additive(s) of 15% by weight or less, preferably 10% by weight or less, more preferably 7% by weight or less, still more preferably 5% by weight or less, even more preferably 4% by weight or less, even more preferably 3 to 4% by weight, based on 100% by weight of the total weight of the filament.
103. The filament of any one of items 70 to 102, wherein a diameter of the filament is 1.0 mm or more, preferably 1.5 mm or more, more preferably 1.6 mm or more, even more preferably 1.7 mm or more; and wherein a diameter of the filament is 5.0 mm or less, preferably 4.0 mm or less, more preferably 3.5 mm or less, even more preferably 3.0 mm or less.
104. The filament of item 103, wherein a diameter of the filament is within a range of 1.70 mm to 1.80 mm.
105. The filament of item 103, wherein a diameter of the filament is within a range of from 2.80 to 3.05 mm.
106. The filament of any one of items 70 to 105, wherein the filament is biodegradable in accordance with EN 13432.
107. The filament of any one of items 70 to 106, wherein the filament is not:
   a fiber being obtainable or being obtained by a method comprising:
      spinning a melt comprising an aliphatic polyester, an aliphatic-aromatic polyester, and a polyhydroxyalkanoate through a hollow fiber spinning nozzle to obtain a precursor fiber; and
      cooling the precursor fiber under a temperature gradient, thereby obtaining the fiber.
108. The filament of any one of items 70 to 107, wherein the filament is not:
   a fiber being made from a mixture comprising an aliphatic polyester, an aliphatic-aromatic polyester, and a polyhydroxyalkanoate,
   wherein the fiber comprises, in a longitudinal direction, two kinds of portions, wherein the one kind of portions are thicker portions and the other kinds of portions are thinner portions, wherein said thicker portions and thinner portions extend in a vertical direction relative to the longitudinal direction of the fiber, and wherein an extension in the vertical direction of a thicker portion is greater than an extension in the vertical direction of a thinner portion;
   wherein at least a part of the thicker portions has a cavity, and at least a part of the thinner portions has a compact structure.
109. The filament of any one of items 70 to 108, wherein the filament is not:
   a hollow fiber being made from a mixture comprising an aliphatic polyester, an aliphatic-aromatic polyester, and a polyhodroxyalkanoate.
110. The filament of any one of items 70 to 109, wherein the filament is not a segmented fiber or a segmented hollow fiber.
111. A roll comprising a filament suitable for three-dimensional printing of any one of items 70 to 110.
112. A cartridge suitable for a three-dimensional printer, comprising a filament suitable for three-dimensional printing of any one of items 70 to 110.
113. A three-dimensionally printed article, obtainable or being obtained by subjecting a filament suitable for three-dimensional printing of any one of items 70 to 110 to three-dimensional printing.
114. A method of preparing a filament suitable for three-dimensionally printing according to any one of items 70 to 110, comprising extruding a melt comprising an aliphatic polyester, an aliphatic-aromatic polyester, and a polyhydroxyalkanoate into the form of a filament.
114a. The method of item 114, wherein a temperature of the melt is in a range of from 200° C. to 260° C., preferably of from 220° C. to 250° C., more preferably of from 230° C. to 250° C., still more preferably of from 230 to 240° C.
115. The method of item 114, wherein the melt comprises the aliphatic polyester in an amount of from 30 to 70% by weight based on 100% by weight of the combined amount of the aliphatic polyester, the aliphatic-aromatic polyester, and the polyhydroxyalkanoate.
116. The method of item 114 or 115, wherein the melt comprises the aliphatic-aromatic in an amount of from 10 to 60% by weight based on 100% by weight of the combined amount of the aliphatic polyester, the aliphatic-aromatic polyester, and the polyhydroxyalkanoate.
117. The method of any one of items 114 to 116, wherein the melt comprises the polyhydroxyalkanoate in an amount of from 1 to 25% by weight based on 100% by weight of the combined amount of the aliphatic polyester, the aliphatic-aromatic polyester, and the polyhydroxyalkanoate.
118. The method of any one of items 114 to 117, wherein the melt comprises the aliphatic polyester in an amount of from 42 to 62% by weight, the aromatic-aliphatic polyester in an amount of from 26 to 46% by weight, and the polyhydroxyalkanoate in an amount of from 2 to 22% by weight based on 100% by weight of the combined amount of the aliphatic polyester, the aromatic-aliphatic polyester, and the polyhydroxyalkanoate.
119. The method of any one of items 114 to 118, wherein the polyhydroxyalkanoate is partially or totally replaced by a polylactide.
120. The method of any one of items 114 to 119, wherein the melt further comprises at least one additive.
121. The method of item 120, wherein the at least one additive is selected from the group consisting of a flame retardant, a matting agent, a fluorescence marker, an antimicrobial agent, a plasticizer, a filler, and any combination thereof.
122. The method of item 121, wherein the additive is a flame retardant.
123. The method of item 122, wherein the melt comprises the flame retardant in an amount of from 0.01 to 5% by weight, preferably 0.1 to 4% by weight, more preferably 0.2 to 3% by weight, still more preferably 0.3 to 2% by weight, based on 100% by weight of the total weight of the melt.
124. The method of any one of items 120 to 123, wherein the total amount of additive(s) is 15% by weight or less, preferably 10% by weight or less, more preferably 7% by weight or less, still more preferably 5% by weight or less, even more preferably 4% by weight or less, even more preferably 3 to 4% by weight, based on 100% by weight of the total weight of the melt.
125. The method of any one of items 114 to 124, wherein the method is not:
   a method of preparing a fiber, comprising:
      spinning a melt comprising an aliphatic polyester, an aliphatic-aromatic polyester, and a polyhydroxyalkanoate through a hollow fiber spinning nozzle to obtain a precursor fiber; and
      cooling the precursor fiber under a temperature gradient, thereby obtaining the fiber.
126. A filament obtainable or being obtained by a method of any one of items 114 to 125.
127. Use of a melt comprising an aliphatic polyester, an aliphatic-aromatic polyester, and a polyhydroxyalkanoate for the preparation of a filament suitable for three-dimensional printing, wherein the filament is defined as in any one of items 70 to 110.
128. Use of a melt comprising an aliphatic polyester, an aliphatic-aromatic polyester, and a polyhydroxyalkanoate for the preparation of a filament suitable for three-dimensional printing.
129. Use of a mixture comprising an aliphatic polyester, an aliphatic-aromatic polyester, and a polyhydroxyalkanoate for the preparation of a filament suitable for three-dimensional printing, wherein the filament is defined as in any one of items 70 to 110.
130. Use of a mixture comprising an aliphatic polyester, an aliphatic-aromatic polyester, and a polyhydroxyalkanoate for the preparation of a filament suitable for three-dimensional printing.

A better understanding of the present invention and of its advantages will be provided by the following examples, offered for illustrative purposes only. The examples are not intended to limit the scope of the present invention in any way.

### EXAMPLES

### Example 1: Preparation of a Fiber According to an Embodiment of the Invention

The following components (polymer I, polymer II, polymer III and a masterbatch of additives) were used for preparation of a fiber in accordance with an embodiment of the invention:
Polymer I: Polybutylene succinate (PBS, Mitsubishi Chemicals Bio PBS FZ71, bio-based)
Polymer II: Polybutylene adipate terephthalate (PBAT, BASF ECOFLEX PBAT)
Polymer III: Poly(3-hydroxybutyrate-co-3-hydroxyhexanoate) (PBHB, KANEKA AONILEX X151A, bio-based)
Masterbatch: The masterbatch comprises the additives in the amounts as indicated in the following Table 1PG-9I

TABLE 1

| | | |
|---|---|---|
| 10% by | Zinc sulfide | Matting of the fiber, |
| weight | (Kremer Zinksulfid 46350, | increase of melting |
| | Kremer Pigmente GmbH & | point |
| | Co. KG, Aichstetten, | |
| | Germany) | |
| 22% by | di-ammonium hydrogen | Flame retardant |
| weight | phosphate ((NH₄)₂HPO₄) | |
| | (EMSURE ®, Sigma Aldrich | |
| | product number 1.01207, | |
| | Millipore) | |
| 50 PPB | Fluorescent particles | Marker for |
| | (oligomers from Polysecure | authentication |
| | GmbH, Freiburg im Breisgau, | |
| | Germany) | |
| 13% by | SMARTZINC 213 PET Hot | Antimicrobial agent |
| weight | Melt (zinc encapsulated with | |
| | polyethylene therephthalate, | |
| | Smartpolymer GmbH, | |
| | Rudolstadt, Germany) | |
| 55% by | Filler (wood plastic composite | Filler |
| weight | (WPC)) | |
| | Chromated copper arsenate | |
| | (CCA)-free | |
| | High-purity lignin | |
| | GRAANUL Biotech (Sweet | |
| | Woods), Tallinn, Estonia | |
| 100% by | | |
| weight (sum) | | |

A fiber according to an embodiment of the invention was prepared using a Fourné pilot melt spintester (year of construction 2013, Fourné Maschinenbau GmbH, Alfter-Impekoven, Germany) with a retrofitted module for side flow allowance of the masterbatch additives, a spinning nozzle (any spinning nozzle suitable for melt spinning of fibers can be used; in the present example, the nozzle has a circular orifice and is not a hollow fiber spinning nozzle), and a fiber after treatment line. Further external processing was carried out on the fiber aftertreatment line using the steps of reed, intake structure, dipping bath, drafting system I, stretching bath, drafting system II, steaming, drafting system III, reviving roller, crimping, drying and staple cutting machine.

Polymer I (15,600 g, polybutylene succinate (PBS)), polymer II (10,800 g, polybutylene adipate terephthalate (PBAT)) and polymer III (3,600 g, poly(3-hydroxybutyrate-co-3-hydroxyhexanoate) (PHBH)) were added as granules to the melt spinning machine. Further, 1.650 kg of the masterbatch (additives) in powder form was added via the simple screw feeder into the module for side flow allowance. The moisture content was about 0.1% by weight. Polymers I, II and III, and the masterbatch (additives) were dried at 60° C. for 24 hours in a vacuum drying cabinet before the addition.

The following process parameters were used:
flow rate: 2.5 kg/h up to 5.12 m/min tow;
processing temperature: 230 to 250° C. (such as, e.g., 235° C.);
distance between spinning nozzle and godet: 200 cm;
take-off godet: 85° C. 800 m/min;
godet roller 1: 80° C. 980 m/min;
godet roller 2: 80° C. 1350 m/min;
cooling was effected using air cooling to provide air flows onto the precursor fiber from both sides.

A melt spinning apparatus, which can be used for preparing the fiber, and a process for the preparation of the fiber is schematically depicted in FIG. 1. The melt spinning apparatus of FIG. 1 comprises a spinning nozzle 1 having a circular orifice. A melt comprising the three polymers, which in the present Example has a processing temperature of 250° C., is spun through the spinning nozzle 1 (not a hollow fiber spinning nozzle in the present Example), by using an extruder, to obtain a hot precursor fiber 3. An air flow 7 is provided onto the precursor fiber 3 from both sides, to cool the precursor fiber 3. The air flow 7 may be provided by air cooling aggregates, which are schematically implied by the snow flakes. In the present example, the air used for the air flow 7 has ambient temperature (about 20° C.). The air cooling results in the fiber 11. The fiber 11 is then wound up by godet rolls 13.

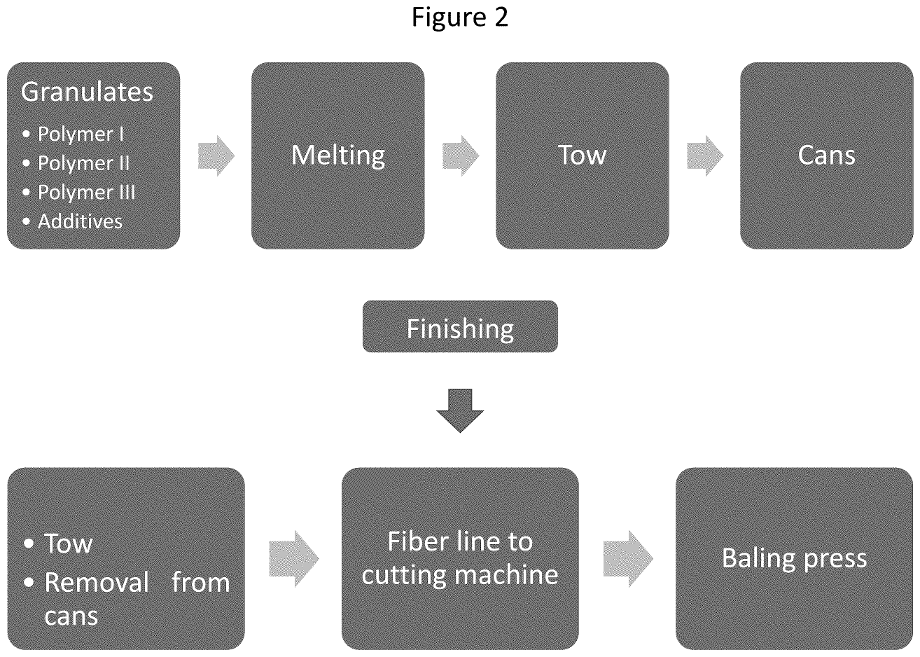

FIG. 2 shows an extended scheme of preparing a fiber and further processing of the fiber by after treatment, according to an embodiment of the invention. As indicated in FIG. 2, the fiber may undergo, e.g., finishing, cutting and pressing into bales.

### Example 2: Antimony Content Test

The antimony content of a fiber obtained as e.g. in Example 1 was tested by the Laboratory Dr. Matt, Schaan, Liechtenstein. In principle, antimony, which is a toxic element, can be present as residues from the catalysts used during the production process of the polymers.

The antimony content was tested as follows:

The fibers of Example 1 were inserted into water and (a) heated to the boiling point of water; (b) stored in the water for 8 weeks; and (c) further stored 4 weeks in a glass with water and air (closed, ⅓ of air, ⅔ of water).

No antimony could be detected in the fiber and in the water (antimony S6<0.1 mg/kg ICP-MS). Thus, this test shows that the fiber can be prepared without using toxic antimony.

### Example 3: Further Characteristics of a Fiber According to an Embodiment of the Invention

Further characteristics of the fiber according to an embodiment of the invention (obtained as described e.g. in Example 1) compared to known commercially available fibers used for the production of textiles are set out in the following Table 2.

TABLE 2

| | | | | | | | Possible | | |
|---|---|---|---|---|---|---|---|---|---|
| | | | | | | | with | | |
| | | | | | | | proportion | | Land |
| | | | | | | | of | | consumption |
| | Flame | | | | | | renewable | Water | per 1 ton |
| | retardant | | Free of | Biodegradable | Dirt- | Wrinkle- | raw | consumption/ | (1000 kg) |
| Staple | (B1) | Hydrophilic | Antimony | EN 13432 | repellent | resistant | materials | kg | of fiber |
| Fiber | X | X | X | X | X | X | X | 0.4% | 0.19 |
| according | | | | | | | | | |
| to an | | | | | | | | | |
| embodiment | | | | | | | | | |
| of the | | | | | | | | | |
| invention* | | | | | | | | | |
| Diolen | | | | | X | X | | 0.5% | 0.002 |
| Trevira CS | X | | | | X | X | | 0.5% | 0.002 |
| Tencel | | X | X | X | | | X | 1.5% | 0.24 |
| Viscose | | X | X | X | | | X | 2.6% | 0.69 |
| (Lenzing) | | | | | | | | | |
| Cotton | | X | X | X | | | X | 50% | 0.82 |
| Wool | X | X | X | X | X | X | X | 100% | 170 |

*Fiber obtained as described e.g. in Example 1.
“X” denotes that the respective characteristic is fulfilled.

As can be seen from Table 2, the fiber according to an embodiment of the invention can be prepared with a flame retardant, is hydrophilic, can be prepared free of antimony, is biodegradable in accordance with EN 13432, is dirt-repellent, is wrinkle resistant, and can be prepared with a proportion of renewable raw materials. The preparation of the fiber according to an embodiment of the invention requires a water consumption which is much lower than for cotton. Further, the area requirement per 1 ton (1000 kg) for the preparation of the fiber according to an embodiment of the invention is also much lower than for cotton. Accordingly, the fiber according to an embodiment of the invention is beneficial from an ecological point of view compared to cotton.

### Example 4: Clothing Comprising a Fiber According to an Embodiment of the Invention

A fiber according to an embodiment of the invention (obtained as described e.g. in Example 1), in particular a yarn made from the fiber, has been used to produce a shirt.

FIG. 3 is a photograph which, inter alia, shows granules 15 of a mixture that can be used for preparing a fiber or a filament suitable for injection molding in accordance with the invention. FIG. 3 also depicts fibers 17 in accordance with embodiments of the invention (obtained as described, e.g., in Example 1), and a yarn 19 made from the fiber, which is wound on a bobbin. FIG. 3 also shows shirts 21 made from the fiber, in particular from a yarn made from the fiber, which comprise about 40% of the fiber according to an embodiment of the invention, and about 60% cotton. FIG. 4 is a photograph which shows further views of the shirts 21.

### Example 5: Preparation of a Filament for Three-Dimensional Printing According to an Embodiment of the Invention

The same components (polymer I, polymer II, polymer III and the masterbatch of additives according to Table 1) as described in Example 1 were also used for the preparation of a filament for three-dimensional printing in accordance with an embodiment of the invention.

Polymer I (15,600 g, polybutylene succinate (PBS)), polymer II (10,800 g, polybutylene adipate terephthalate (PBAT)) and polymer III (3,600 g, poly(3-hydroxybutyrate-co-3-hydroxyhexanoate) (PHBH)) were mixed with 1.650 kg of the masterbatch (additives). The moisture content was about 0.1% by weight. Polymers 1, 11 and Ill, and the masterbatch (additives) were dried at 60° C. for 24 hours in a vacuum drying cabinet before the addition.

A melt was prepared and extruded from a nozzle having a diameter of 2.5 mm at a melt temperature of 230 to 250° C. (such as, e.g., 235° C.) using a single-axe melting-kneading extruder, and then cooled in water at 40° C. to obtain a filament having a diameter of 1.75 mm.

A filament 23 suitable for three-dimensional printing in accordance with an embodiment of the invention, which can be prepared as described, e.g., in present Example 5, is depicted in FIG. 3.

The filament was used to produce a plastic card in the format of a credit card on a conventional 3D printer operating under the material extrusion method.

1. A fiber being made from a mixture comprising an aliphatic polyester, an aliphatic-aromatic polyester, and a polyhydroxyalkanoate, wherein the aliphatic polyester comprises an aliphatic C₂-C₂₀ dicarboxylic acid and an aliphatic C₂-C₁₂ diol.

2. The fiber of claim 1, wherein the fiber is not a hollow fiber, or wherein the fiber is not a segmented fiber or a segmented hollow fiber.

3.-6. (canceled)

7. The fiber of claim 1, wherein the aliphatic polyester is a polybutylene succinate (PBS), the aliphatic-aromatic polyester is a polybutylene adipate terephthalate (PBAT), and the polyhydroxyalkanoate is a poly(3-hydroxybutyrate-co-3-hydroxhexanoate) (PHBH).

8. (canceled)

9. The fiber of claim 1, wherein the fiber is a textile fiber.

10. The fiber of claim 1, wherein the fiber further comprises at least one additive, wherein the at least one additive comprises lignin.

11.-12. (canceled)

13. The fiber of claim 1, wherein the fiber is a staple fiber, or wherein the fiber is a filament, and/or wherein the fiber is biodegradable in accordance with EN 13432.

14.-16. (canceled)

17. A yarn comprising a fiber of claim 1.

18. A textile comprising a fiber of claim 1.

19. A method of preparing a fiber according to claim 1, comprising:
spinning a melt comprising an aliphatic polyester, an aliphatic-aromatic polyester, and a polyhydroxyalkanoate through a spinning nozzle to obtain a precursor fiber; and
cooling the precursor fiber, thereby obtaining the fiber,
wherein the aliphatic polyester comprises an aliphatic C₂-C₂₀ dicarboxylic acid and an aliphatic C₂-C₁₂ diol.

20.-25. (canceled)

26. A fiber obtainable or being obtained by a method according to claim 19, wherein the fiber is not a hollow fiber.

27. A method of preparing a fiber using:
(a) a melt comprising an aliphatic polyester, an aliphatic-aromatic polyester, and a polyhydroxyalkanoate for the preparation of a fiber, wherein the aliphatic polyester comprises an aliphatic C₂-C₂₀ dicarboxylic acid and an aliphatic C₂-C₁₂ diol, or
(b) a mixture comprising an aliphatic polyester, an aliphatic-aromatic polyester, and a polyhydroxyalkanoate for the preparation of a fiber, wherein the aliphatic polyester comprises an aliphatic C2-C20 dicarboxylic acid and an aliphatic C2-C12 diol.

28. (canceled)

29. A filament suitable for three-dimensional printing being made from a mixture comprising an aliphatic polyester, an aliphatic-aromatic polyester, and a polyhydroxyalkanoate, wherein the aliphatic polyester comprises an aliphatic C₂-C₂₀ dicarboxylic acid and an aliphatic C₂-C₁₂ diol.

30.-33. (canceled)

34. The filament of claim 29, wherein the aliphatic polyester is a polybutylene succinate (PBS), the aliphatic-aromatic polyester is a polybutylene adipate terephthalate (PBAT), and the polyhydroxyalkanoate is a poly(3-hydroxybutyrate-co-3-hydroxhexanoate) (PHBH).

35. (canceled)

36. The filament of claim 29, wherein the filament further comprises at least one additive, wherein the at least one additive comprises lignin, and/or wherein the filament is biodegradable in accordance with EN 13432.

37.-39. (canceled)

40. The filament of claim 29, wherein the filament is not:
a fiber being obtainable or being obtained by a method comprising:
spinning a melt comprising an aliphatic polyester, an aliphatic-aromatic polyester, and a polyhydroxyalkanoate through a hollow fiber spinning nozzle to obtain a precursor fiber; and
cooling the precursor fiber under a temperature gradient, thereby obtaining the fiber and/or
wherein the filament is not:
a fiber being made from a mixture comprising an aliphatic polyester, an aliphatic-aromatic polyester, and a polyhydroxyalkanoate,
wherein the fiber comprises, in a longitudinal direction, two kinds of portions, wherein the one kind of portions are thicker portions and the other kinds of portions are thinner portions,
wherein said thicker portions and thinner portions extend in a vertical direction relative to the longitudinal direction of the fiber, and wherein an extension in the vertical direction of a thicker portion is greater than an extension in the vertical direction of a thinner portion;
wherein at least a part of the thicker portions has a cavity, and at least a part of the thinner portions has a compact structure and/or
wherein the filament is not:
a hollow fiber being made from a mixture comprising an aliphatic polyester, an aliphatic-aromatic polyester, and a polyhydroxyalkanoate and/or
wherein the filament is not a segmented fiber or a segmented hollow fiber.

41. A roll comprising a filament suitable for three-dimensional printing of claim 29.

42. A cartridge suitable for a three-dimensional printer, comprising a filament suitable for three-dimensional printing of claim 29.

43. A three-dimensionally printed article, obtainable or being obtained by subjecting a filament suitable for three-dimensional printing of claim 29 to three-dimensional printing.

44. A method of preparing a filament suitable for three-dimensionally printing according to claim 29, comprising extruding a melt comprising an aliphatic polyester, an aliphatic-aromatic polyester, and a polyhydroxyalkanoate into the form of a filament,
wherein the aliphatic polyester comprises an aliphatic C₂-C₂₀ dicarboxylic acid and an aliphatic C₂-C₁₂ diol.

45.-49. (canceled)

50. A filament obtainable or being obtained by a method of claim 44.

51.-52. (canceled)

53. A textile comprising a yarn of claim 17.
